(19) United States
(12) Patent Application Publication
(10) Pub. No.: US 2016/0263483 A1
(43) Pub. Date: Sep. 15, 2016

(54) FANTASY SPORTS SYSTEMS HAVING PREDICTIVE SCORING

(71) Applicant: Jean Christophe Le, Silver Spring, MD (US)

(72) Inventor: Jean Christophe Le, Silver Spring, MD (US)

(21) Appl. No.: 14/658,056

(22) Filed: Mar. 13, 2015

(51) Int. Cl. A63F 13/828; A63F 13/65

(52) U.S. Cl. CPC A63F 13/828; A63F 13/65

(57) ABSTRACT

A fantasy game system includes a display to present fantasy game information, inputs to accept user input, and a processor coupled thereto to present the fantasy game information, process the user input, and facilitate a fantasy game played competitively by multiple game participants regarding an independently verifiable public endeavor, such as a professional sports league. Each game participant manages a separate fantasy team involving a subset of the players or activities from the public endeavor, and at least a portion of the scoring is based upon the relative accuracy of a game participant in predicting statistically the performances of players or activities prior to the actual performances taking place. The system can also provide data regarding fantasy game performance predictions made by other game participants, such as averages of multiple performance predictions for various players or activities of the public endeavor.

### TECHNICAL FIELD

The present invention relates generally to game systems and methods, and more particularly to fantasy or rotisserie sports and related games.

### BACKGROUND

Puzzles, games, and other competitions have long been a huge source of amusement, entertainment, and even learning for young and old alike. Games can include sports, board games, card games, role-playing games, video games, and the like. Some games can fall under multiple types of categories, such as those listed above and/or others. Many types of games can be done alone or with other people, such as to foster cooperative play or even to encourage family time or extended interactions with friends, colleagues, or current or old schoolmates.

One particular type of game or competition can involve fantasy or rotisserie sports or similar endeavors. As is generally well known, games such as fantasy football or rotisserie baseball can involve multiple participants selecting various players to fill out their own “teams” or rosters, where the performances of such selected players then results in daily or weekly scoring for the team or teams that own such players. Such scoring can generally be competitive, such as where periodic and/or cumulative scores are compared against other “team owners” that compete each other in a given league. As is generally known, it is typical to convert actual game performance statistics to scores in a fantasy style league, while it is common to rank performance statistics and score by relative rankings in a rotisserie style league. Other forms of fantasy games or leagues based on other formats are also possible, and the formation of teams or rosters can be by way of draft, auction, or salary cap, as well as other possible processes. While such fantasy or rotisserie games or leagues are popular for football and baseball, such games can also be played with respect to basketball, hockey, soccer, tennis, golf, car racing, and other sports, as well as for stock markets, media awards, music, and consumer product development and successes, among many other possible endeavors.

Despite the wide variety of offerings that are available, many game and fantasy sport enthusiasts still desire further variety when it comes to these types of games. As such, while rotisserie baseball, fantasy football, and other existing games have worked well over many years, there is always a desire for improvement and new variations. In particular, what is desired are new varieties of fantasy games that provide new rules or styles while still appealing to many users so as to remain popular and fun to play.

### SUMMARY

It is an advantage of the present disclosure to provide new varieties of fantasy systems and games that provide new rules or styles while still appealing to many users so as to remain popular and fun to play. This can be accomplished at least in part through the implementation and use of fantasy games where at least a portion of the scoring for each separate fantasy team is based upon the relative accuracy in predicting the performances of players or other activities on the fantasy team prior to the actual performances taking place. In particular, the more accurate a game participant is in predicting the performances of his or her fantasy players in advance, the higher the score becomes for his or her fantasy team.

Embodiments of the present disclosure can include an apparatus or system used to administer, provide, or play the fantasy game, computer code or software that enables the play of the fantasy game, and various methods of administering or playing the fantasy game itself.

In various embodiments, a fantasy game apparatus adapted to provide a fantasy game for play to a user can include at least a display device, one or more input devices, and a processor. The display device can be adapted to present fantasy game information to a user regarding the play of a fantasy game, while the one or more input devices can be adapted to accept input from the user regarding the play of the fantasy game. The processor can be coupled to the display device and input devices, and can also be adapted to process the user input, provide the fantasy game information, and facilitate the play of a fantasy game related thereto, where the fantasy game can be played competitively by a plurality of game participants, including the user, regarding one or more separate and independently verifiable public endeavors, such as a sports league. For the fantasy game, each of the plurality of game participants is provided with the ability to manage a separate fantasy team involving a subset of the players or activities from the one or more public endeavors. Further, at least a portion of the scoring for each separate fantasy team can be based upon the relative accuracy of its respective game participant or “owner” in predicting the performances of the subset of players or activities from the one or more public endeavors on the fantasy team prior to the actual performances taking place when compared with the actual performances.

In various detailed embodiments, the fantasy game is a fantasy sports game and one of the public endeavors is a sports league. For example, the sports league can be a professional football, baseball, or basketball league. In some arrangements, another of the one or more public endeavors can be a collegiate sports organization of the same sport as the professional sports league, such that the subset of players on a given fantasy team can include players from the professional sports league and also players from the collegiate sports association. In various embodiments, a plurality of the fantasy teams form a fantasy league whereby each player or activity from the public endeavor can be placed onto no more than one fantasy team in the fantasy league. In various alternative embodiments, a plurality of the fantasy teams form a fantasy league whereby each player or activity from the public endeavor can be placed onto multiple fantasy teams in the fantasy league.

In various detailed embodiments, game participants can predict each of a plurality of individual statistical performances for each of their respective players or activities that are on their fantasy teams. In various embodiments, game participants can predict an overall fantasy score based on a plurality of individual statistical performances for each of their respective players or activities on their fantasy teams. In some such arrangements, each of the plurality of game participants can be provided with an overall fantasy score budget cap for the sum of all predictions for all of his or respective players or activities from the public endeavor that are on his or her fantasy team. In various embodiments, each game participant can be awarded higher scores in the fantasy game by predicting the performances of its players or activities with higher accuracy. In some such arrangements, scores in the fantasy game can be awarded as a combination of at least a first portion based upon the relative accuracy of predicting the performances of players or activities from the public endeavor when compared with the actual performances, and also a second portion based upon the actual performances of the players or activities from the public endeavor.

In various detailed embodiments, the fantasy game apparatus can further include a communication interface coupled to the processor and adapted to facilitate communications between the processor and an outside computing network. In such embodiments, the communication interface can be adapted to provide data to the processor regarding fantasy game performance predictions made by other game participants who are not users of the instant fantasy game apparatus. In such arrangements, this data can include averages of multiple performance predictions for the same individual statistical performances of the same player or activity of the public endeavor.

Further embodiments include various methods of providing a fantasy game to a fantasy game participant. Again, the fantasy game can be played competitively by a plurality of game participants regarding separate and independently verifiable public endeavor(s), wherein each of the plurality of game participants is provided with the ability to manage a separate fantasy team involving a subset of the players or activities from the public endeavor(s). Pertinent process steps can include presenting to a user via a display device fantasy game information regarding the play of a fantasy game, as well as accepting an input from the user via an input device, with the input involving one or more choices from the user regarding the management of his or her fantasy team, where such choices include a specific statistical prediction regarding a performance of at least one player or activity from the public endeavor on the fantasy team prior to the actual performance taking place. Further process steps can include receiving information regarding the actual performance of the at least one player or activity, comparing automatically by a processor the specific statistical prediction with the actual performance of the player or activity; and assigning automatically by a processor at least a portion of a score to the user based on the accuracy of the specific statistical prediction in comparison with the actual performance.

Various specific embodiments can again include where the public endeavor is a professional football, baseball, or basketball league. Also, the one or more choices can include a plurality of individual statistical performance predictions for each of the players or activities on the fantasy team. Additional process steps can include receiving data regarding multiple fantasy game performance predictions that have been made by fantasy game participants other than the user, and then providing to the user averages of the received multiple fantasy game performance predictions. Such data can be made available for informational, reference, or entertainment purposes.

Still further embodiments include various computer readable media including at least computer program code for presenting a fantasy game using a fantasy game apparatus. The computer readable media can include computer program code for presenting to a user fantasy game information regarding the play of a fantasy game, computer program code for accepting an input from the user, computer program code for receiving information regarding actual performance of a player or activity, computer program code for comparing automatically by a processor a specific statistical prediction with the actual performance of the player or activity, and computer program code for assigning automatically by a processor at least a portion of a score to the user based on the accuracy of the specific statistical prediction in comparison with the actual performance. Further details with respect to each of these computer program codes can accord with that which is set forth above regarding the various methods of providing a fantasy game.

Additional embodiments involve systems or networks that administer or include the provided fantasy game, and any such apparatuses, systems, methods and the like can include any or all of the foregoing features in any combination.

Other apparatuses, systems, methods, features and advantages of the disclosure will be or will become apparent to one with skill in the art upon examination of the following figures and detailed description. It is intended that all additional apparatuses, systems, methods, features and advantages be included within this description, be within the scope of the disclosure, and be protected by the accompanying claims.

### BRIEF DESCRIPTION OF THE DRAWINGS

The included drawings are for illustrative purposes and serve only to provide examples of possible structures and arrangements for the disclosed inventive apparatuses, systems and methods for fantasy sports systems having predictive scoring. These drawings in no way limit any changes in form and detail that may be made to the disclosure by one skilled in the art without departing from the spirit and scope of the disclosure.

FIG. 1A illustrates in front perspective view an exemplary computing device according to one embodiment of the present disclosure.

FIG. 1B illustrates in front perspective view an alternative exemplary computing device according to one embodiment of the present disclosure.

FIG. 1C illustrates in block diagram format an exemplary computerized data network according to one embodiment of the present disclosure.

FIG. 2 illustrates a diagram of an exemplary client or end user computing device or system according to one embodiment of the present disclosure.

FIG. 3 illustrates in block diagram format an exemplary client system for a mobile device according to one embodiment of the present disclosure.

FIG. 4 illustrates in block diagram format an exemplary server system according to one embodiment of the present disclosure.

FIG. 5 illustrates in block diagram format an exemplary application server system according to one embodiment of the present disclosure.

FIG. 6 illustrates an image of an exemplary webpage based fantasy game system according to one embodiment of the present disclosure.

FIG. 7 provides a flowchart of an exemplary basic method of providing a predictive fantasy sports game to a fantasy game participant according to one embodiment of the present disclosure.

FIG. 8 illustrates an image of an exemplary graphical user interface for providing a predictive fantasy sports game to a game participant on a computing device according to one embodiment of the present disclosure.

FIGS. 9-15 illustrate various further images of exemplary graphical user interfaces for providing a predictive fantasy sports game to a game participant on a computing device according to various embodiments of the present disclosure.

FIG. 16 provides a flowchart of an exemplary detailed method of providing a predictive fantasy sports game and data therefor to a fantasy sports game participant according to one embodiment of the present disclosure.

### DETAILED DESCRIPTION

Exemplary applications of apparatuses and methods according to the present disclosure are described in this section. These examples are being provided solely to add context and aid in the understanding of the disclosure. It will thus be apparent to one skilled in the art that the present disclosure may be practiced without some or all of these specific details. In other instances, well known process steps have not been described in detail in order to avoid unnecessarily obscuring the present disclosure. Other applications are possible, such that the following examples should not be taken as limiting.

In the following detailed description, references are made to the accompanying drawings, which form a part of the description and in which are shown, by way of illustration, specific embodiments of the present disclosure. Although these embodiments are described in sufficient detail to enable one skilled in the art to practice the disclosure, it is understood that these examples are not limiting, such that other embodiments may be used, and changes may be made without departing from the spirit and scope of the disclosure.

The present disclosure relates in various embodiments to devices, systems and methods for providing, conducting and facilitating the play of fantasy games. Such fantasy games may be played manually amongst family, friends, and others, as well as on one or more computing devices, such as over a system or network. As such, this disclosure may be applied to any form of providing fantasy games, whether on a computing device or otherwise. Although the various examples set forth herein are focused on computerized versions over the Internet or other network for the disclosed fantasy games, it will be readily understood that such fantasy games can be played in a number of different ways and modes, such as with physical scorecards or items, such that the disclosure is not limited only to computerized embodiments.

Furthermore, it will be understood that the various exemplary fantasy games presented herein are merely examples of the myriad possibilities that can be used for playing such games. While fantasy football, rotisserie baseball, fantasy basketball and the like are popular and well known, it is specifically contemplated that the disclosed systems and methods can be used with respect to any separate and independently verifiable public endeavor that is suitable for fantasy games. Such other public endeavors can include other sports, at any or all of professional, collegiate, amateur, or other levels. Alternatively, or in addition, such public endeavors can also include other items such as stock markets, politics, game shows, television awards shows, movies, and the like. For purposes of simplicity in discussion and illustration, however, reference will be made herein primarily with respect to fantasy football games. It will be readily appreciated that the detailed examples directed thereto can be extrapolated or similarly applied to any other sports, leagues, or public endeavors used for fantasy games.

In general, fantasy sports games can be comprised of contests between game participants whereby these participants initially draft a fantasy team or “roster” made up of players, teams, activities, or other “members” from active collegiate or professional sport teams, pending whether the relevant fantasy league involves a collegiate fantasy sport game or a professional fantasy sport game, respectively. Such contests between game participants can involve head-to-head matchups, overall points totals, and/or tournaments, among other possible scenarios. Again, such fantasy games can also extend to other endeavors beyond just sports teams and leagues, as will be readily appreciated.

A fantasy “draft” describes the situation whereby one or more game participants form a roster or rosters by the action of selecting players, teams, activities, or other members (collectively “players” herein for purposes of discussion) from a pool of players and teams in professional or collegiate sport teams prior to a fantasy sport contest. The most common draft formats include standard draft, auction, and salary cap formats. Standard drafts involve game participants taking turns selecting available players for their fantasy teams or rosters. This can be done in “linear” draft fashion with the same draft order taking place every round, or in “snake” draft fashion where the draft order reverses at the end of each round. Alternative standard drafts can also be used, such as where the draft order is randomly determined for every round. Standard draft formats typically result in any given player from the sport or other public endeavor being on only one fantasy team roster in the fantasy league. These types of standard drafts are common for fantasy leagues with a set number of participants.

Auction draft formats generally involve game participants taking turns to nominate players to be drafted, whereupon all players then have an opportunity to bid on the nominated players. The game participant with the highest bid then drafts that player to his or her roster, and the bid amount is counted against an overall team budget for that winning participant. Auction formats are also common for fantasy leagues with a set number of game participants. Auction formats also typically result in leagues where a given player can be on only one team roster for the whole league. For salary cap format leagues, players can be assigned a pre-determined value, whereby participants have a limited salary budget to bid on the value of these players. These leagues can involve situations where a given player can only go to one team, or where a given player can be on multiple teams without limit as may be desired by the various respective game participants. Typically one-day fantasy sport games utilize this type of draft.

After a draft to form rosters, a game participant may select a “starting lineup” for his or her roster for a given day, week, or other time period, which can then be repeated with possible adjustments over the course of a fantasy game season. Selecting or designating a starting lineup means to assign players (typically by position) from the roster into the available respective starting slots (typically by position) that the game participant wants to start in competing for fantasy points in a contest. After a starting lineup is set, there will often be remaining players from the roster that are not in the starting lineup and are thus ineligible to score fantasy points for the contest, with such remaining players often being termed the “bench” for that contest. In some embodiments, however, participants may not necessarily need to draft a roster and narrow down a starting lineup, as there may be games where drafting an immediate starting lineup is a preferred way to play. One-day fantasy sport games are one potential example.

A common objective for fantasy sports games is to select a starting lineup that can potentially yield the highest total amount of fantasy points for the contest for that team. When considering which players to set into the starting lineup, game participants may research and/or consider the opinions, analytical assessments, or “expert advice” from their own notes, family and friends, and/or sports media outlets, such as, for example, fantasy sports game platform providers, sports websites, sports television newscasts, blogs, and the like. Between participants, the highest total of fantasy points scored by starting lineups in the contest typically wins. Scoring of fantasy points per the members in a starting lineup can be based upon the calculation of actual game performance metrics generated by the respective players in real life. The longevity of a fantasy sport contest can range from a one-day contest to a season-long league with multiple contests, such as mirroring the actual sport season. In general, success in winning a contest against other participant(s) can be determined by a quantitative approach whereby usually the highest quantity of total points scored wins (barring a tie score).

As is generally well known, a typical scoring approach for many fantasy sports games and other fantasy games utilizes a quantitative approach whereby contest outcomes are determined by the totality of points scored between participants. Such a quantitative approach can involve, for example, assigning 6 points for every touchdown scored by a player, and/or 1 point for every 10 yards gained by a player. Many other categories and point awards are also used and well known for football and many other sports. As such, it is typically desirable to “own” players on a team roster where such players are prolific scorers and performers in the real NFL, NCAA, or other sports league. Higher real life performances translate to more fantasy points scored in typical fantasy sports leagues.

As one particular feature of the present disclosure, alternative fantasy sports game (and other fantasy game) systems can alternatively or also include a qualitative or predictive scoring approach. This unique system allows game participants to draft and project or predict various variable(s) or individual statistics for players in a fantasy team. These projected or predicted variables can then be qualitatively measured, by a system calculating the percent accuracy, on how close or accurate they are to the corresponding actual resulting variable(s) or statistics in real life. For example, rather than starting Joe Runningback (JR) and collecting 6 points for every touchdown and 1 point for every 10 yards gained that week for JR, a participant playing in this system would start JR and then predict how well JR would do this week, such as: “JR—1 touchdown and 80 yards.” This projection or prediction can then be compared against the actual performance of JR, and an accuracy score can then be awarded based upon the accuracy of the prediction.

The accuracy of these qualitative measurements can then be used across many statistical categories for many or all starting players to determine outcomes for fantasy sport game contests between game participants in the same contest. By utilizing a qualitative scoring approach for game participant projections, participants will have new playing experiences for any fantasy sport games whereby participants are scored or “graded” on the accuracy of their lineup. This new type of playing experience of drafting and projecting can help promote a new nature of competition between participants. Given the more extensive nature of logging projections in advance, comparing projections with actual results to determine accuracy, and assigning or awarding accuracy score based on relative accuracies of projections or predictions, it is specifically contemplated that the presently disclosed fantasy games, systems, and methods be used in conjunction with one or more processing devices, such as over the Internet or other network.

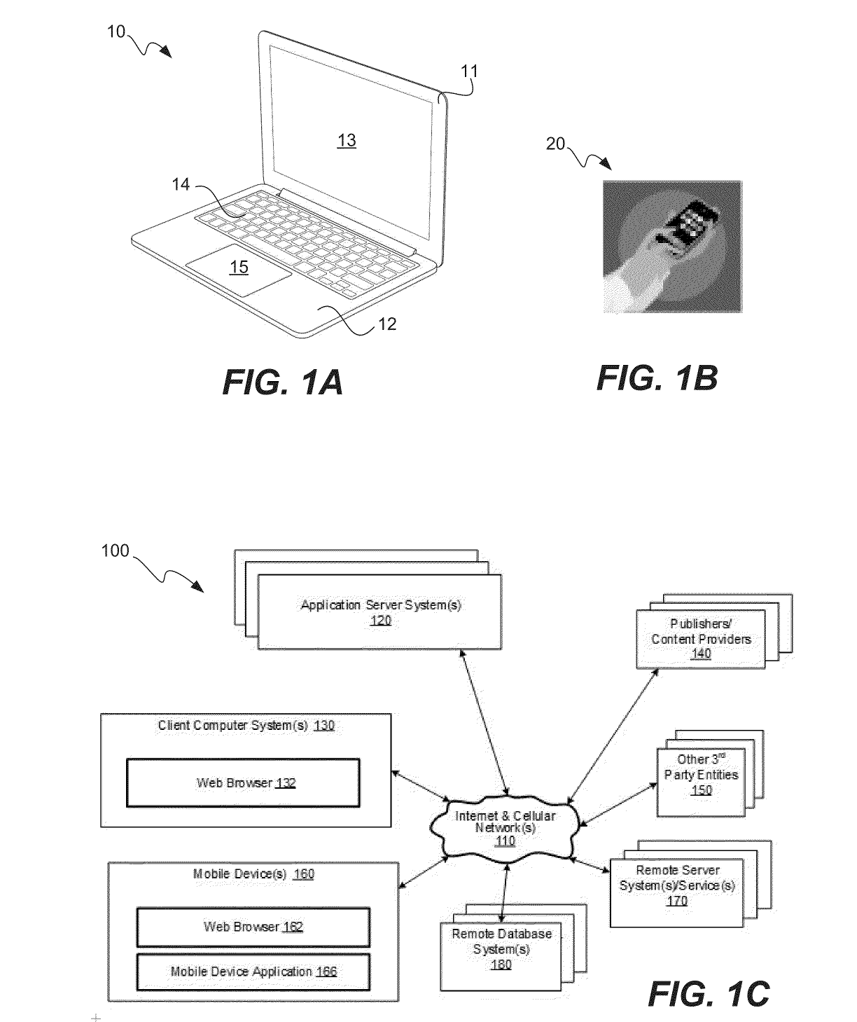

Referring first to FIG. 1A, an exemplary computing device according to one embodiment of the present disclosure is illustrated in front perspective view. Computing device 10, which can be a laptop computer, can be particularly adapted to provide various fantasy games to a user as provided herein. It will be readily appreciated that computing device 10 can be provided in numerous other configurations and formats while still being able to provide the disclosed fantasy games, such that the provided laptop example is for illustrative purposes only. For example, computing device 10 could also be a desktop computer, tablet computer, smart phone, personal digital assistant, or the like.

In general, computing device 10 can include an upper portion 11 and a lower portion 12. Upper portion 11 can include a display component 13 having a display region thereupon, while lower portion 12 can include various input devices, such as a keyboard 14 and touchpad 15. Lower portion 12 may also include a processor (not shown) therewithin, which can be adapted to process information regarding a fantasy game, provide display output regarding the fantasy game, and accept user input regarding the fantasy game, which again can be a fantasy sports game. Such a processor can be coupled to the display component 13 and the input devices 14, 15, as well as other components of the computing device. Such other computing device components or items not shown may also be included, as will be readily appreciated, with such items including, for example, speakers, memories, busses, input ports, disk drives, power supplies, wireless interfaces, and the like.

FIG. 1B illustrates in front perspective view an alternative exemplary computing device according to one embodiment of the present disclosure. Smart phone 20 can similarly be used to provide and facilitate the play of a fantasy sports game or other similar fantasy game. As in the foregoing computing device 10, smart phone 20 can include at least a processor, display component having a display region, and one or more input devices, such as a touchscreen, button(s) and/or a keypad. In various embodiments, a fantasy sports game or the like can be provided as an application or “app” on an app store that can be accessed from smart phone 20. Such an app can be downloaded and then played or used on the phone 20.

FIG. 1C illustrates in block diagram format an exemplary computerized data network according to one embodiment of the present disclosure. Computerized data network 100 can be used to implement a “Predictive Fantasy Gaming System” adapted for the play of predictive based fantasy sports games and/or other similar fantasy games, for example. As described in greater detail herein, different embodiments of Predictive Fantasy Gaming Systems may be configured, designed, and/or operable to provide various different types of operations, functionalities, and/or features generally relating to these types of fantasy games.

According to different embodiments, at least some Predictive Fantasy Gaming Systems may be configured, designed, and/or operable to provide a number of different advantages and/or benefits and/or may be operable to initiate, and/or enable various different types of operations, functionalities, and/or features. According to different embodiments, at least a portion of the various types of functions, operations, actions, and/or other features provided by the Predictive Fantasy Gaming System may be implemented at one or more client systems, at one or more server systems, and/or combinations thereof.

According to different embodiments, the Predictive Fantasy Gaming System 100 may include a plurality of different types of components, devices, modules, processes, systems, and the like, which, for example, may be implemented and/or instantiated via the use of hardware and/or combinations of hardware and software. For example, as illustrated in the example embodiment of FIG. 1C, network 100 may include one or more of the following types of systems, components, devices, processes, etc. (or combinations thereof):
Application Server System(s) 120—In at least one embodiment, the Application Server System(s) may be operable to perform and/or implement various types of functions, operations, actions, and/or other features such as those described or referenced herein.
Publisher/Content Provider System component(s) 140
Client Computer System (s) 130
3^{rd} Party System(s) 150
Internet & Cellular Network(s) 110
Remote Database System(s) 180
Remote Server System(s)/Service(s) 170, which, for example, may include, but are not limited to, one or more of the following (or combinations thereof):
   Content provider servers/services
   Media Streaming servers/services
   Database storage/access/query servers/services
   Financial transaction servers/services
   Payment gateway servers/services
   Electronic commerce servers/services
   Event management/scheduling servers/services
Mobile Device(s) 160—In at least one embodiment, the Mobile Device(s) may be operable to perform and/or implement various types of functions, operations, actions, and/or other features such as those described or referenced herein.

In at least one embodiment, a Predictive Fantasy Gaming System may be operable to utilize and/or generate various different types of data and/or other types of information when performing specific tasks and/or operations. This may include, for example, input data/information and/or output data/information. For example, in at least one embodiment, a Predictive Fantasy Gaming System may be operable to access, process, and/or otherwise utilize information from one or more different types of sources, such as, for example, one or more local and/or remote memories, devices and/or systems. Additionally, in at least one embodiment, a Predictive Fantasy Gaming System may be operable to generate one or more different types of output data/information, which, for example, may be stored in memory of one or more local and/or remote devices and/or systems. Examples of different types of input data/information and/or output data/information which may be accessed and/or utilized by a Predictive Fantasy Gaming System may include, but are not limited to, one or more of those described and/or referenced herein, such as, for example, consensus data regarding predicted performances.

According to specific embodiments, multiple instances or threads of a Predictive Fantasy Gaming System may be concurrently implemented and/or initiated via the use of one or more processors and/or other combinations of hardware and/or hardware and software. For example, in at least some embodiments, various aspects, features, and/or functionalities of the Predictive Fantasy Gaming System may be performed, implemented and/or initiated by one or more of the various systems, components, systems, devices, procedures, processes, etc., described and/or referenced herein. In at least one embodiment, a given instance of a Predictive Fantasy Gaming System may access and/or utilize information from one or more associated databases. In at least one embodiment, at least a portion of the database information may be accessed via communication with one or more local and/or remote memory devices. Examples of different types of data which may be accessed by a Predictive Fantasy Gaming System may include, but are not limited to, one or more of those described and/or referenced herein.

According to different embodiments, various different types of encryption/decryption techniques may be used to facilitate secure communications between devices in a Predictive Fantasy Gaming System and/or other networks. Examples of the various types of security techniques which may be used may include, but are not limited to, one or more of the following (or combinations thereof): random number generators, SHA-1 (Secured Hashing Algorithm), MD2, MD5, DES (Digital Encryption Standard), 3DES (Triple DES), RC4 (Rivest Cipher), ARC4 (related to RC4), TKIP (Temporal Key Integrity Protocol, uses RC4), AES (Advanced Encryption Standard), RSA, DSA, DH, NTRU, and ECC (elliptic curve cryptography), PKA (Private Key Authentication), Device-Unique Secret Key and other cryptographic key data, SSL, etc. Other security features contemplated may include use of well-known hardware-based and/or software-based security components, and/or any other known or yet to be devised security and/or hardware and encryption/decryption processes implemented in hardware and/or software.

It will be appreciated that the Predictive Fantasy Gaming System of FIG. 1C is but one example from a wide range of Predictive Fantasy Gaming System embodiments which may be implemented. Other embodiments of the Predictive Fantasy Gaming System (not shown) may include additional, fewer and/or different components/features that those illustrated in the exemplary Predictive Fantasy Gaming System embodiment of FIG. 1C. Generally, the various techniques for implementing a predictive fantasy sports game or similar fantasy game described herein may be implemented in software, hardware and/or hardware+software. For example, they can be implemented in an operating system kernel, in a separate user process, in a library package bound into network applications, on a specially constructed machine, or on a network interface card. In a specific embodiment, various aspects described herein may be implemented in software such as an operating system or in an application running on an operating system.

Software, hardware and/or software+hardware hybrid embodiments of the Predictive Fantasy Gaming techniques described herein may be implemented on a general-purpose programmable machine selectively activated or reconfigured by a computer program stored in memory. Such programmable machine may include, for example, mobile or handheld computing systems, PDA, smart phones, notebook computers, tablets, netbooks, desktop computing systems, server systems, cloud computing systems, network devices, and the like.

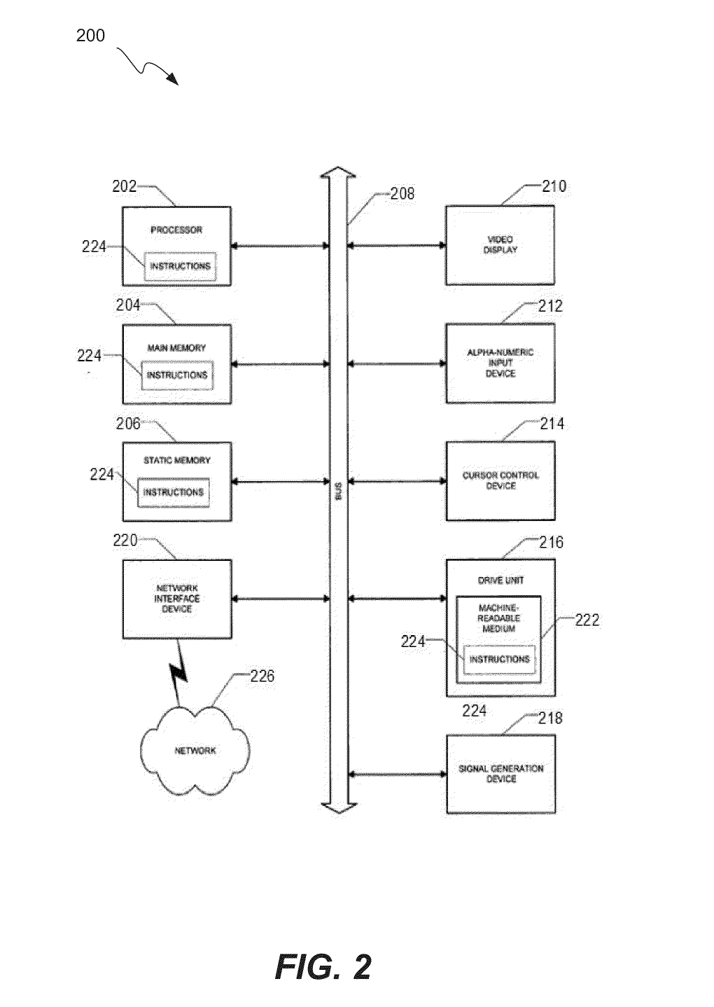

Turning next to FIG. 2, a diagrammatic representation of an exemplary client or end user computing device or system is provided. Computing device or system 200 can be identical or similar to any of the foregoing computer devices 10, 20, as well as any other suitable computing device or system adapted for providing the disclosed Predictive Fantasy Gaming System or other similar fantasy systems.

Computing device or system 200 may contain a set of instructions for causing itself or another networked machine to perform any one or more of the methodologies discussed herein. As such, computing device or system 200 may operate as a standalone device or machine, or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

Exemplary computer device or system 200 includes a processor 202 (e.g., a central processing unit (CPU), a graphics processing unit (GPU) or both), a main memory 204 and a static memory 206, which communicate with each other via a bus 208. The computer device or system 200 may further include a video display unit 210 (e.g., a liquid crystal display (LCD) or a cathode ray tube (CRT)), and also an alphanumeric input device 212 (e.g., a keyboard), a user interface (UI) navigation device 214 (e.g., a mouse), a disk drive unit 216, a signal generation device 218 (e.g., a speaker) and a network interface device 220. The disk drive unit 216 includes a machine-readable medium 222 on which is stored one or more sets of instructions and data structures (e.g., software 224) embodying or utilized by any one or more of the methodologies or functions described herein. The software 224 may also reside, completely or at least partially, within the main memory 204 and/or within the processor 202 during execution thereof by the computer device or system 200, wherein the main memory 204 and/or the processor 202 may also be constituting machine-readable media.

The software 224 may further be transmitted or received over a network 226 via the network interface device 220 utilizing any one of a number of well-known transfer protocols (e. g., HTTP). While the machine-readable medium 222 is shown in an exemplary embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention, or that is capable of storing, encoding or carrying data structures utilized by or associated with such a set of instructions. The term “machine-readable medium” shall accordingly be taken to include, but not be limited to, solid-state memories, optical and magnetic media, and carrier wave signals.

According to various embodiments, computing device or system 200 may include a variety of components, modules and/or systems for providing various types of functionality. For example, in at least one embodiment, device or system 200 may include a web browser application which is operable to process, execute, and/or support the use of scripts (e.g., JavaScript, AJAX, etc.), Plug-ins, executable code, virtual machines, HTML5 vector-based web animation (e.g., Adobe Flash), etc. In at least one embodiment, the web browser application may be configured or designed to instantiate components and/or objects at the device or system 200 in response to processing scripts, instructions, and/or other information received from a remote server such as a web server. Examples of such components and/or objects may include, but are not limited to, UI components, database components, processing components, and other components that may facilitate and/or enable device or system 200 to perform and/or initiate various types of operations, activities, functions such as those described herein with respect to providing predictive fantasy sports games or other similar fantasy games.

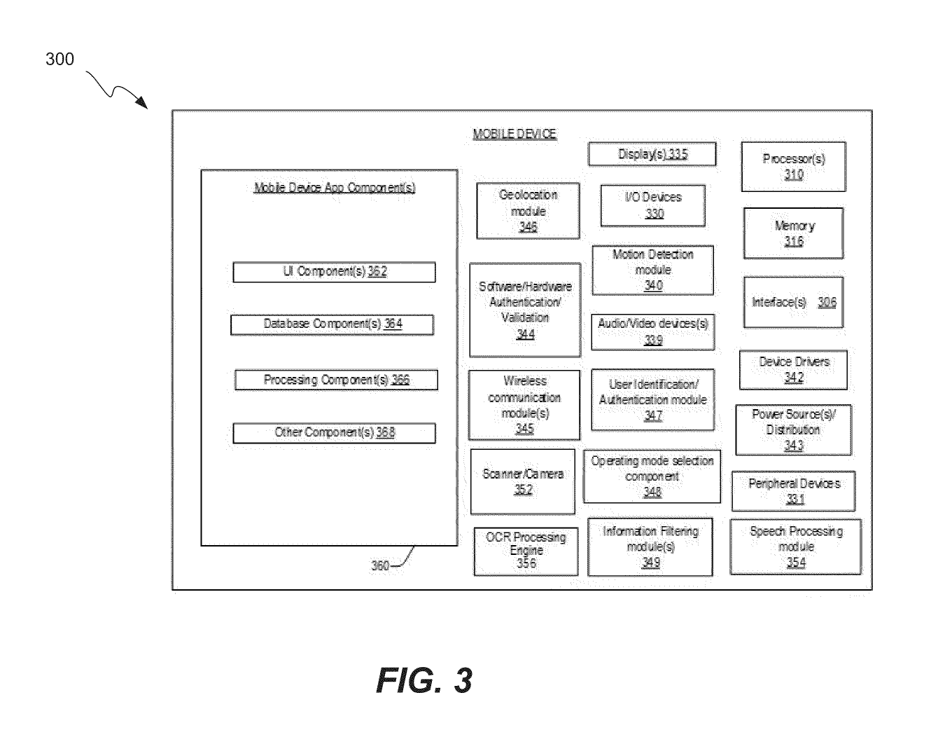

Continuing with FIG. 3, a block diagram of an exemplary client system for a mobile device is provided. In at least one embodiment, the mobile device client system 300 may include a Predictive Fantasy Mobile Device App Component, which has been configured or designed to provide functionality for enabling or implementing at least a portion of the various predictive fantasy gaming techniques at the mobile device client system. Such a mobile device app component can be provided for download by a service provider, such as an app store for smart phone devices. Various aspects, features, and/or functionalities of client system 300 may be performed, implemented and/or initiated by one or more of the following types of systems, components, systems, devices, procedures, processes, and the like. Such items can include, for example: Processor(s) 310, Device Drivers 342, Memory 316, Interface(s) 306, Power Source(s)/Distribution 343, Geolocation module 346, Display(s) 335, I/O Devices 330, Audio/Video devices(s) 339, Peripheral Devices 331, Motion Detection module 340, User Identification/Authentication module 347, Client App Component(s) 360, Other Component(s) 368, UI Component(s) 362, Database Component(s) 364, Processing Component(s) 366, Software/Hardware Authentication/Validation 344, Wireless communication module(s) 345, Information Filtering module(s) 349, Operating mode selection component 348, Speech Processing module 354, Scanner/Camera 352, and OCR Processing Engine 356, among other possible components.

As illustrated in the example of FIG. 3, mobile device 300 may include a variety of components, modules and/or systems for providing various functionality. For example, Mobile Device 300 may include Mobile Device Application components (e.g., 360), which, for example, may include, but are not limited to, one or more of the following (or combinations thereof): UI Components 362, Database Components 364, Processing Components 366, and Other Components 368 which, for example, may include components for facilitating and/or enabling the mobile device to perform and/or initiate various types of operations, activities, functions such as those described herein.

In at least one embodiment, a given instance of the Mobile Device Application component(s) may access and/or utilize information from one or more associated databases. In at least one embodiment, at least a portion of the database information may be accessed via communication with one or more local and/or remote memory devices. Examples of different types of data which may be accessed by the Mobile Device Application component(s) may include, but are not limited to, one or more different types of data, metadata, and/or other information described and/or referenced herein.

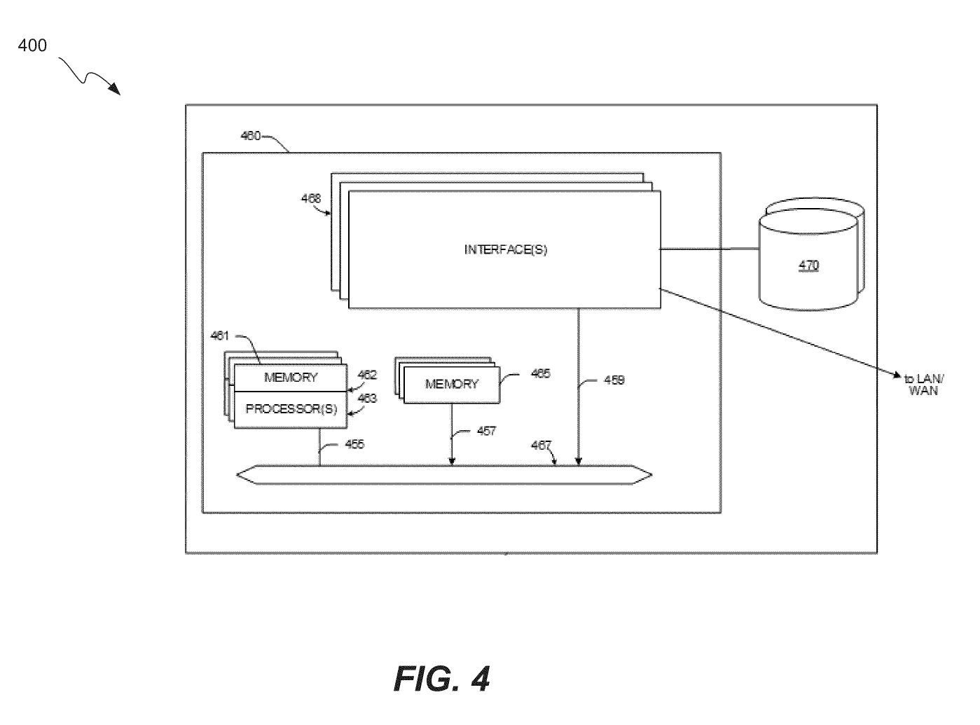

FIG. 4 illustrates in block diagram format an exemplary server system 480, which may be used for implementing various aspects/features described herein. In at least one embodiment, the server system 480 includes at least one network device 460, and at least one storage device 470 (such as, for example, a direct attached storage device). In one embodiment, server system 480 may be suitable for implementing at least some of the predictive fantasy sports gaming techniques described herein.

According to one embodiment, network device 460 may include a master central processing unit (CPU) 462, interfaces 468, and a bus 467 (e.g., a PCI bus). When acting under the control of appropriate software or firmware, the CPU 462 may be responsible for implementing specific functions associated with the functions of a desired network device. For example, when configured as a server, the CPU 462 may be responsible for analyzing packets; encapsulating packets; forwarding packets to appropriate network devices; instantiating various types of virtual machines, virtual interfaces, virtual storage volumes, virtual appliances; etc. The CPU 462 preferably accomplishes at least a portion of these functions under the control of software including an operating system (e.g. Linux), and any appropriate system software (such as, for example, AppLogic™ software).

CPU 462 may include one or more processors 463 such as, for example, one or more processors from the AMD, Motorola, Intel and/or MIPS families of microprocessors. In an alternative embodiment, processor 463 may be specially designed hardware for controlling the operations of server system 480. In a specific embodiment, a memory 461 (such as non-volatile RAM and/or ROM) also forms part of CPU 462. However, there may be many different ways in which memory could be coupled to the system. Memory block 461 may be used for a variety of purposes such as, for example, caching and/or storing data, programming instructions, etc.

The interfaces 468 may be typically provided as interface cards (sometimes referred to as “line cards”). Alternatively, one or more of the interfaces 468 may be provided as on-board interface controllers built into the system motherboard. Generally, they control the sending and receiving of data packets over the network and sometimes support other peripherals used with the server system 480. Among the interfaces that may be provided may be FC interfaces, Ethernet interfaces, frame relay interfaces, cable interfaces, DSL interfaces, token ring interfaces, Infiniband interfaces, and the like. In addition, various very high-speed interfaces may be provided, such as fast Ethernet interfaces, Gigabit Ethernet interfaces, ATM interfaces, HSSI interfaces, POS interfaces, FDDI interfaces, ASI interfaces, DHEI interfaces and the like. Other interfaces may include one or more wireless interfaces such as, for example, 802.11 (WiFi) interfaces, 802.15 interfaces (including Bluetooth™), 802.16 (WiMax) interfaces, 802.22 interfaces, Cellular standards such as CDMA interfaces, CDMA2000 interfaces, WCDMA interfaces, TDMA interfaces, Cellular 3G interfaces, etc.

Generally, one or more interfaces may include ports appropriate for communication with the appropriate media. In some cases, they may also include an independent processor and, in some instances, volatile RAM. The independent processors may control such communications intensive tasks as packet switching, media control and management. By providing separate processors for the communications intensive tasks, these interfaces allow the master microprocessor 462 to efficiently perform routing computations, network diagnostics, security functions, etc. In at least one embodiment, some interfaces may be configured or designed to allow the server system 480 to communicate with other network devices associated with various local area network (LANs) and/or wide area networks (WANs). Other interfaces may be configured or designed to allow network device 460 to communicate with one or more direct attached storage device(s) 470.

Although the system shown in FIG. 4 illustrates one specific network device described herein, it is by no means the only network device architecture on which one or more embodiments can be implemented. For example, an architecture having a single processor that handles communications as well as routing computations, etc. may be used. Further, other types of interfaces and media could also be used with the network device. Regardless of network device's configuration, it may employ one or more memories or memory modules (such as, for example, memory block 465, which, for example, may include random access memory (RAM)) configured to store data, program instructions for the general-purpose network operations and/or other information relating to the functionality of the various predictive fantasy gaming techniques described herein. The program instructions may control the operation of an operating system and/or one or more applications, for example. The memory or memories may also be configured to store data structures, and/or other specific non-program information described herein.

Because such information and program instructions may be employed to implement the systems/methods described herein, one or more embodiments relates to machine readable media that include program instructions, state information, etc. for performing various operations described herein. Examples of machine-readable storage media include, but are not limited to, magnetic media such as hard disks, floppy disks, and magnetic tape; optical media such as CD-ROM disks; magneto-optical media such as floptical disks; and hardware devices that may be specially configured to store and perform program instructions, such as read-only memory devices (ROM) and random access memory (RAM). Some embodiments may also be embodied in transmission media such as, for example, a carrier wave travelling over an appropriate medium such as airwaves, optical lines, electric lines, etc. Examples of program instructions include both machine code, such as produced by a compiler, and files containing higher level code that may be executed by the computer using an interpreter.

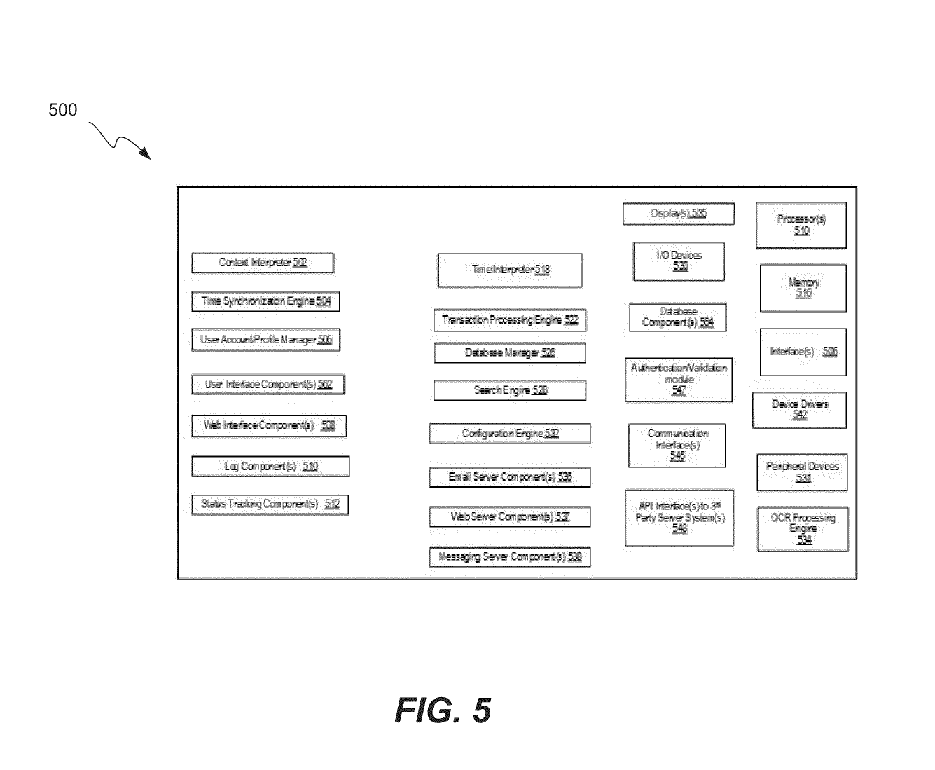

FIG. 5 provides a block diagram of an application server system. Application server system 500 may be operable to perform and/or implement various types of functions, operations, actions, and/or other features associated with providing a predictive fantasy sports game or application. In at least one embodiment, application server system 500 may include a plurality of components operable to perform and/or implement various types of functions, operations, actions, and/or other features such as, for example:
Context Interpreter (e.g., 502) which, for example, may be operable to automatically and/or dynamically analyze contextual criteria relating to a detected set of event(s) and/or condition(s), and automatically determine or identify one or more contextually appropriate response(s) based on the contextual interpretation of the detected event(s)/condition(s). According to different embodiments, examples of contextual criteria which may be analyzed may include, but are not limited to, one or more of the following (or combinations thereof):
   location-based criteria (e.g., geolocation of client device, geolocation of agent device, etc.)
   time-based criteria
   identity of user(s)
   user profile information
   transaction history information
   recent user activities
   proximate business-related criteria (e.g., criteria which may be used to determine whether the client device is currently located at or near a recognized business establishment such as a bank, gas station, restaurant, supermarket, etc.)
Time Synchronization Engine (e.g., 504) which, for example, may be operable to manages universal time synchronization (e.g., via NTP and/or GPS)
Search Engine (e.g., 528) which, for example, may be operable to search for transactions, logs, items, accounts, options in the predictive fantasy databases
Configuration Engine (e.g., 532) which, for example, may be operable to determine and handle configuration of various customized configuration parameters for one or more devices, component(s), system(s), process(es), etc.
Time Interpreter (e.g., 518) which, for example, may be operable to automatically and/or dynamically modify or change identifier activation and expiration time(s) based on various criteria such as, for example, time, location, transaction status, etc.
Authentication/Validation Component(s) (e.g., 547) (password, software/hardware info, SSL certificates) which, for example, may be operable to perform various types of authentication/validation tasks such as, for example, one or more of the following (or combinations thereof):
   verifying/authenticating devices,
   verifying passwords, passcodes, SSL certificates, biometric identification information, and/or other types of security-related information
   verify/validate activation and/or expiration times
In one implementation, the Authentication/Validation Component(s) may be adapted to determine and/or authenticate the identity of the current user or owner of the mobile client system. For example, in one embodiment, the current user may be required to perform a log in process at the mobile client system in order to access one or more features. In some embodiments, the mobile client system may include biometric security components which may be operable to validate and/or authenticate the identity of a user by reading or scanning The user's biometric information (e.g., fingerprints, face, voice, eye/iris, etc.). In at least one implementation, various security features may be incorporated into the mobile client system to prevent unauthorized users from accessing confidential or sensitive information.
Transaction Processing Engine (e.g., 522) which, for example, may be operable to handle various types of transaction processing tasks such as, for example, one or more of the following (or combinations thereof):
   identifying/determining transaction type
   determining which payment gateway(s) to use
   associating databases information to identifiers
OCR Processing Engine (e.g., 534) which, for example, may be operable to perform image processing and optical character recognition of images such as those captured by a mobile device camera, for example.
Database Manager (e.g., 526) which, for example, may be operable to handle various types of tasks relating to database updating, database management, database access, etc. In at least one embodiment, the Database Manager may be operable to manage TISS databases, Predictive Fantasy Device Application databases, etc.
Log Component(s) (e.g., 510) which, for example, may be operable to generate and manage transactions history logs, system errors, connections from APIs, etc.
Status Tracking Component(s) (e.g., 512) which, for example, may be operable to automatically and/or dynamically determine, assign, and/or report updated transaction status information based, for example, on the state of the transaction. In at least one embodiment, the status of a given transaction may be reported as one or more of the following (or combinations thereof): Completed, Incomplete, Pending, Invalid, Error, Declined, Accepted, etc.
Gateway Component(s) (e.g., 514) which, for example, may be operable to facilitate and manage communications and transactions with external Payment Gateways.
Web Interface Component(s) (e.g., 508) which, for example, may be operable to facilitate and manage communications and transactions with predictive fantasy sports web portal(s).
API Interface(s) to Application Server System(s) (e.g., 546) which, for example, may be operable to facilitate and manage communications and transactions with API Interface(s) to Application Server System(s)
API Interface(s) to 3rd Party Server System(s) (e.g., 548) which, for example, may be operable to facilitate and manage communications and transactions with API Interface(s) to 3rd Party Server System(s)
OCR Processing Engine (e.g., 534) which, for example, may be operable to perform image processing and optical character recognition of images such as those captured by a mobile device camera, for example.
At least one processor 510. In at least one embodiment, the processor(s) 510 may include one or more commonly known CPUs which are deployed in many of today's consumer electronic devices, such as, for example, CPUs or processors from the Motorola or Intel family of microprocessors, etc. In an alternative embodiment, at least one processor may be specially designed hardware for controlling the operations of the mobile client system. In a specific embodiment, a memory (such as non-volatile RAM and/or ROM) also forms part of CPU. When acting under the control of appropriate software or firmware, the CPU may be responsible for implementing specific functions associated with the functions of a desired network device. The CPU preferably accomplishes all these functions under the control of software including an operating system, and any appropriate applications software.
Memory 516, which, for example, may include volatile memory (e.g., RAM), non-volatile memory (e.g., disk memory, FLASH memory, EPROMs, etc.), unalterable memory, and/or other types of memory. In at least one implementation, the memory 516 may include functionality similar to at least a portion of functionality implemented by one or more commonly known memory devices such as those described herein and/or generally known to one having ordinary skill in the art. According to different embodiments, one or more memories or memory modules (e.g., memory blocks) may be configured or designed to store data, program instructions for the functional operations of the mobile client system and/or other information relating to the functionality of the various Mobile Transaction techniques described herein. The program instructions may control the operation of an operating system and/or one or more applications, for example. The memory or memories may also be configured to store data structures, metadata, identifier information/images, and/or information/data relating to other features/functions described herein. Because such information and program instructions may be employed to implement at least a portion of the Predictive Fantasy Gaming System techniques described herein, various aspects described herein may be implemented using machine readable media that include program instructions, state information, etc. Examples of machine-readable media include, but are not limited to, magnetic media such as hard disks, floppy disks, and magnetic tape; optical media such as CD-ROM disks; magneto-optical media such as floptical disks; and hardware devices that are specially configured to store and perform program instructions, such as read-only memory devices (ROM) and random access memory (RAM). Examples of program instructions include both machine code, such as produced by a compiler, and files containing higher level code that may be executed by the computer using an interpreter.
Interface(s) 506 which, for example, may include wired interfaces and/or wireless interfaces. In at least one implementation, the interface(s) 506 may include functionality similar to at least a portion of functionality implemented by one or more computer system interfaces such as those described herein and/or generally known to one having ordinary skill in the art.
Device driver(s) 542. In at least one implementation, the device driver(s) 542 may include functionality similar to at least a portion of functionality implemented by one or more computer system driver devices such as those described herein and/or generally known to one having ordinary skill in the art.
One or more display(s) 535. According to various embodiments, such display(s) may be implemented using, for example, LCD display technology, OLED display technology, and/or other types of conventional display technology. In at least one implementation, display(s) 535 may be adapted to be flexible or bendable. Additionally, in at least one embodiment the information displayed on display(s) 535 may utilize e-ink technology (such as that available from E Ink Corporation, Cambridge, Mass., www.eink com), or other suitable technology for reducing the power consumption of information displayed on the display(s) 535.
Email Server Component(s) 536, which, for example, may be configured or designed to provide various functions and operations relating to email activities and communications.
Web Server Component(s) 537, which, for example, may be configured or designed to provide various functions and operations relating to web server activities and communications.
Messaging Server Component(s) 538, which, for example, may be configured or designed to provide various functions and operations relating to text messaging and/or other social network messaging activities and/or communications.

It will be readily appreciated that the various fantasy sports games and other fantasy games can be provided, administered, and played on some or all of the foregoing computing devices, computerized data networks, client systems, server systems, networks including the Internet, and/or mobile devices and systems therefor. It is also understood that various other suitable computing devices, clients, servers and/or networks can be used alternatively or in addition to the foregoing items for the disclosed fantasy games and game systems. Such devices, servers, and networks can be used to provide “apps” and/or browsers that allow for fantasy game administration and play.

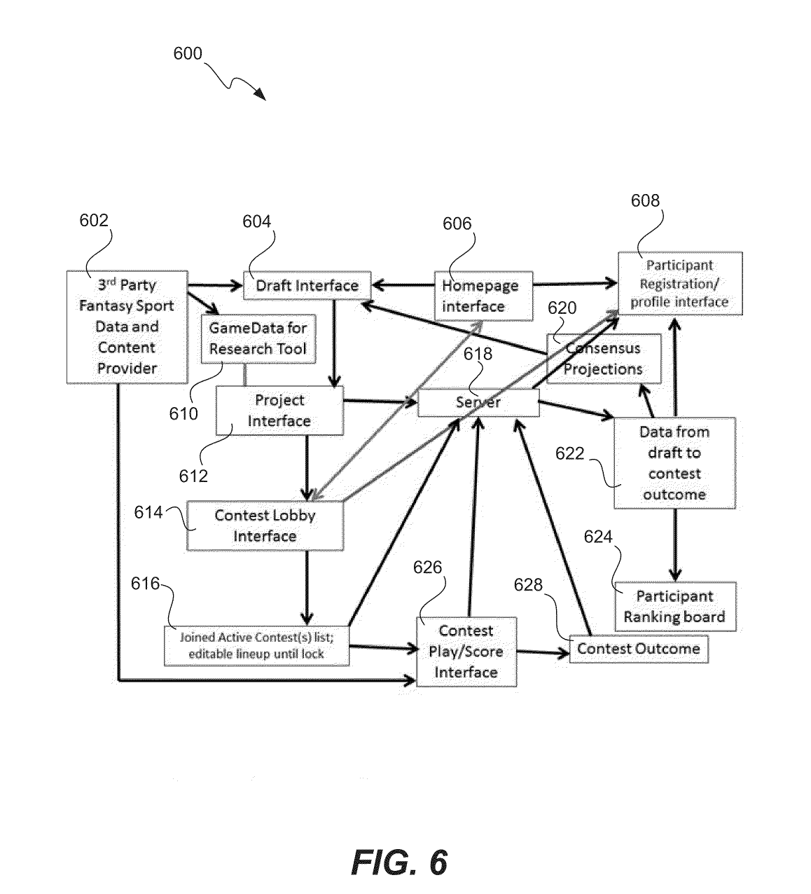

Transitioning now to FIG. 6, an exemplary layout for a webpage based fantasy game system is provided. Fantasy game system 600 can include various entities and/or webpages, as shown, which together provide for the playing of a fantasy sports game or other fantasy game for a plurality of users or game participants. System 600 can include a link or connection to a third party fantasy sport data and content provider 602, and can also include one or more servers that provide a centralized cloud-based network and storage, for example. Various web pages or interfaces on system 600 can be accessed as shown from each other, and can include, for example, draft interface 604, homepage interface 606, participant registration or profile interface 608, a game data for research tool 610, project interface 612, contest lobby interface 614, joined active contest(s) list page 616, server 618, consensus projection page 620, data from draft to contest outcome page 622, participant ranking board page 624, contest play and score interface 626, and contest outcome page 628, among other possible interfaces and pages.

Various items in system 600, such as, for example, server 618, can perform a variety of functions, such as store participant data, store fantasy sport contest data, and/or host a server side user interface. Such a user interface can include a drafting platform or interface 604, a projecting platform or interface 612, a player or team research platform or tool 610, a contest lobby platform or interface 614, a score and game-play tracking platform or interface 626, and a participant profile page 608, among other items.

In various embodiments, system 600 may be provided with the ability to extrapolate or import fantasy sports data from one or more third party fantasy sport data providers 602. System 600 may also act autonomously or automatically to determine fantasy sport scoring and outcomes pertaining to the disclosed fantasy game method and qualitative scoring system. In various embodiments, system 600 can also be adapted to provide and manage a reward system pertaining to the disclosed fantasy game method and qualitative scoring system, such as through server 618 and/or one or more other administrator or host controllers.

Additional functions that can be provided on system 600 include overseeing or managing the server, such as via a hosting service, defining and implementing contests and scoring rules, communicating with the various game participants (e.g., registration, game play, troubleshooting, contest advertisement, promotion solicitation, etc.), as well as facilitating or moderating reward rules and payouts, contest-lobby issues, and contest-related matters between game participants (e.g., scoring disputes, contest outcomes, etc.). Not all of the foregoing items, webpages, and/or functions are necessary, and it will be readily appreciated that other items, webpages, and/or functions may also be provided as may be desired by a given game provider or operator, as will be readily appreciated.

In various embodiments, a predictive scoring based fantasy game and system is provided. As noted above, the particular fantasy systems that are provided herein can use a scoring system having at least a portion that is based upon the relative accuracy of all game participants in predicting the performances of players, teams, or other activities on their fantasy teams prior to the actual performances taking place. Game participants are then provided with higher game scores when they are more accurate in predicting the actual performances of fantasy players or activities in advance. This can effectively be termed a “qualitative” or “predictive” scoring approach, where the projected or predicted variables or categories for each player or activity are qualitatively measured. The accuracy of these qualitative measurements can then be used across many statistical categories for many or all starting players or activities on a fantasy team to determine outcomes for fantasy sport game contests between game participants in the same contest.

In various further embodiments, which can be included with the various predictive scoring based fantasy games and systems, ongoing or current data regarding predictions or projections for various active players or activities already made by others can be collected, stored, averaged or otherwise manipulated, and then provided to game participants. For example, a projected variable or statistic that has already been predicted or projected for a fantasy player, team, or activity by other game participants in multiple lineups and contests within the system can serve as raw data for other game participants. That raw data or a portion thereof can be provided directly, and/or the overall system can use the raw data to calculate with and provide an average for the corresponding variable or statistic. In other words, this provided average can be considered a “consensus projection” by those that have already entered their predictions or projections, which consensus projection can then be used as a reference to aid other game participants when projecting the same or a similar variable or statistic for that corresponding fantasy player, team, or activity during subsequent lineup setting and projecting phases in the system. Other uses for and manipulations of the raw data can also take place, which other uses can then also be provided to game participants if desired.

In various further embodiments, which can be included within one or both of the foregoing embodiments, the same data exhaust set forth above that can be collected, stored, averaged, and otherwise manipulated, can also serve as overall big data that can be used external to the overall fantasy game system. In other words, the collected and/or averaged or otherwise manipulated data can also be provided to other outlets and mediums, such as, for example, another fantasy sport data provider. Such use of “crowd-sourced” data and averages may prove useful for other providers, and as such can be provided for free and/or on a paid or other prescription basis, as may be desired.

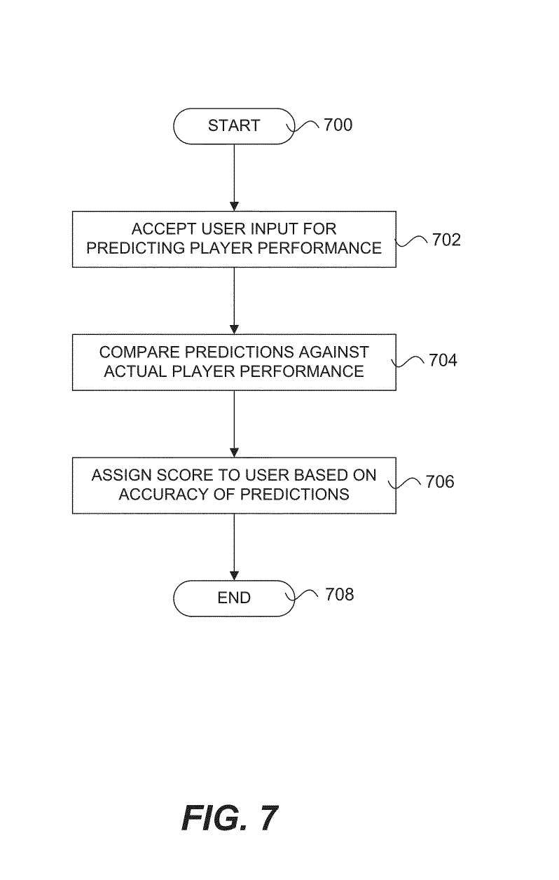

Referencing FIG. 7, a flowchart of one exemplary basic method of providing a predictive fantasy sports game to a fantasy game participant according to one embodiment of the present disclosure is illustrated. After a start step 700, user input(s) for predicting a player performance is accepted at a process step 702. Such a “user input” can be made to a computing device, as will be readily appreciated. Also, it is understood that the “user” can be a “game participant” that plays the fantasy sports game or other fantasy game, while a “player” can be a player that is on an actual sport team, such as a professional or collegiate football team. Furthermore, the term “player” can be generic for any entity that is on the roster of a fantasy team, which can include any players, teams (e.g., defenses or special teams), or other activities from a public endeavor that may be on a fantasy roster. These understood terms can be applied as necessary here and throughout the present disclosure as may be suitable and appropriate.

At a following process step 704, the prediction(s) input by the user for a player are then compared against the actual player performance. For example, the number of rushing yards predicted for a player are compared against the actual number of rushing yards gained by that player during the subject game or games. At a subsequent process step 706, a score is then assigned to the user based upon the accuracy of the prediction(s). Again, a higher or better score is assigned where the prediction is more accurate. This basic method then ends at end step 708.

For the foregoing flowchart, it will be readily appreciated that not every method step provided is always necessary, and that further steps not set forth herein may also be included. For example, added steps can involve providing software or game pieces, allowing a difficulty setting, and/or providing an opponent score or contest outcome, among other possible steps. Furthermore, the exact order of steps may be altered as desired, and some steps may be performed simultaneously. For example, steps 704 and 706 could be considered as being performed simultaneously in various embodiments, particularly where a processor is being used for rapid computations. Not all steps are always necessary either. For example, step 706 may not be performed in all embodiments. Also, while the provided examples are with respect to computerized fantasy games, it will be readily appreciated that the provided methods can also be used with respect to fantasy games that involve the use of physical pieces, posters, scorecards, score sheets, and leader boards, as well as other alternative embodiments.

With the basic nature of a predictive scoring based fantasy game and system set forth above, various details and particular embodiments will now be provided with respect to many other aspects of such fantasy sports games and other fantasy games and systems. It will be readily appreciated that these details and particular embodiments are illustrative in nature, and that not all such details and/or embodiments must be used to practice the disclosed predictive fantasy games and systems.

In various embodiments of the present disclosure, an “unrestricted” draft format can be used with a predictive scoring based fantasy game or system. Unlike any of the foregoing draft examples, an unrestricted draft format can allow game participants to draft to their fantasy rosters players, teams, or other activities from more than just a single sports league or organization. For example, a game participant may elect to draft professional and collegiate players to the same fantasy team. In the event of a fantasy football league, for example, this could mean that both NFL players and NCAA football players can exist and start on the same fantasy team roster. Alternatively, NBA and NCAA basketball players might exist and start on the same fantasy roster. Such multiple league availability might also extend to high school leagues, foreign leagues, and/or other professional leagues and organizations for football. Because scoring is completely or primarily based upon the accuracy of game participant predictions, any inherent disparities or inequalities between professional, collegiate, foreign, and other leagues are minimized. That is, focus can be on whether or not a game participant predicts or projects player performance accurately, rather than on the raw statistical totals for the various players. As such, fantasy leagues or tailored contests can be set up having parameters that allow game participants to draft players from various leagues.

In various further or alternative embodiments, fantasy leagues or contests can be set up with parameters that restrict or limit which players can be drafted. For example, a particular fantasy league or contest may provide challenging parameters where game participants can only draft players from the AFC West division of the NFL. Other specifications and restrictions can similarly be applied as may be desired, such as, for example, allowing the draft of only players from the West Coast or East Coast, whether pro or college. A fixed salary budget may or may not be used for such drafts, as may be desired. In the event that game participants do not need to strategically allocate funds from a fixed salary budget to draft a player, they will be able to freely and quickly select any active collegiate and/or professional players for their fantasy team. In comparison to the standard, auction, and salary cap draft formats noted above, utilizing an unrestricted draft format advantageously provides more combination possibilities for drafting a fantasy team. In essence, participants can draft their own “dream teams” across pro, college, and/or other ranks without the budget restrictions from salary cap draft formats or the potential to have numerous players unavailable as in standard and auction draft formats.

In various embodiments, a “Draft Interface” on a computing device can be provided to a user or game participant in order to aid with the drafting of players onto a fantasy team. Such a draft interface can allow the user to enter a new fantasy league or contest in order to select players for his or her fantasy team. Game participants can select available players from a pool of active players from collegiate, professional, and/or other sports teams or leagues for a given sport. The selection list of active players for the draft interface can be provided by the overall system in proprietary fashion, or by a third-party provider data and content provider specializing in fantasy sports (e.g., www.stats.com). Provided it is the same type of sport (e.g. football, basketball, baseball), game participants can choose to draft players exclusively from only a collegiate or professional league, or game participants may choose to draft players in a combination of collegiate, professional, and/or other teams or leagues.

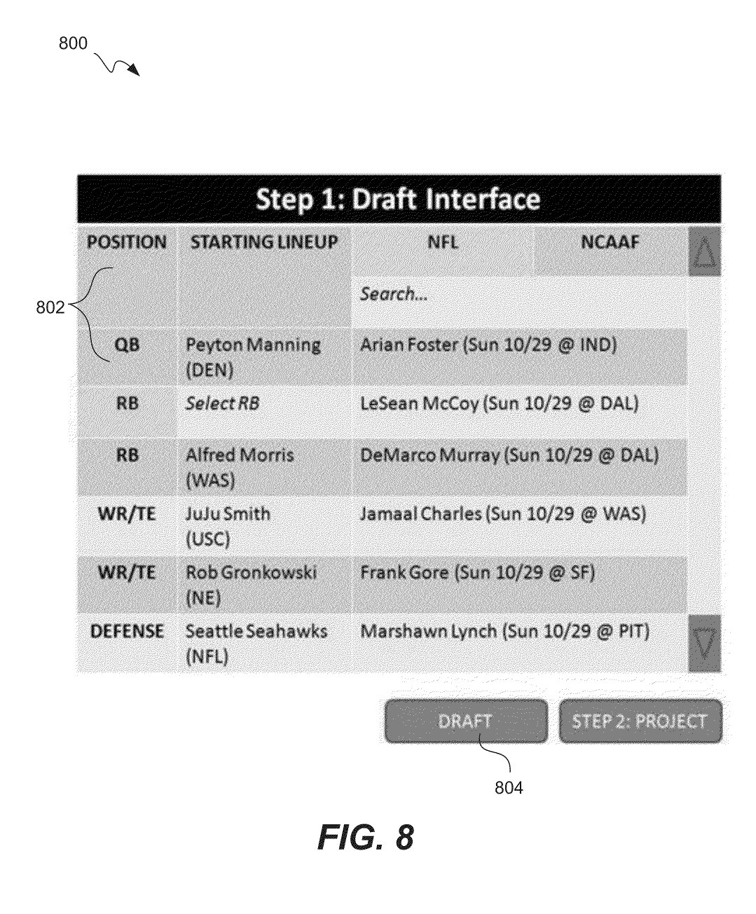

Turning now to FIG. 8, an image of an exemplary graphical user interface for providing a predictive fantasy sports game to a game participant on a computing device is illustrated. As shown, graphical user interface (“GUI”) 800 presents a “draft interface” or web page that allows a game participant to draft players onto his or her fantasy team roster. Various informational items 802 can include headers, such as positions, lineups, and leagues, as well as specific information, such as the actual player or players that have been drafted or that are being reviewed as possible draft choices. One or more buttons 804 on GUI 800 can allow the user or game participant to draft a particular player, such as one that might be selected or highlighted, for example,

Per the “Position” slot or column, which the game participant can click or select to highlight what or who he or she wishes to draft, a list of eligible players to select from can appear for that particular position in organized and tabulated fashion, such as by professional league or collegiate league. Game participants may also have the ability to quickly search by player name under the selected league. In order to draft a player (i.e., player, team, activity, or other) from the list, game participants may click to highlight the player name, which can include real game time and information, from a scrollable list and then click the “Draft” button 804 to insert that player onto the team and/or into the starting lineup. The selected player may then automatically populate into a respective highlighted slot of the starting lineup that was initially selected. Once a full roster and/or starting lineup is drafted, game participants may elect to utilize a “Step 2: Project” or other similar button (initially grayed-out or inactive) to move to a project interface or other page.

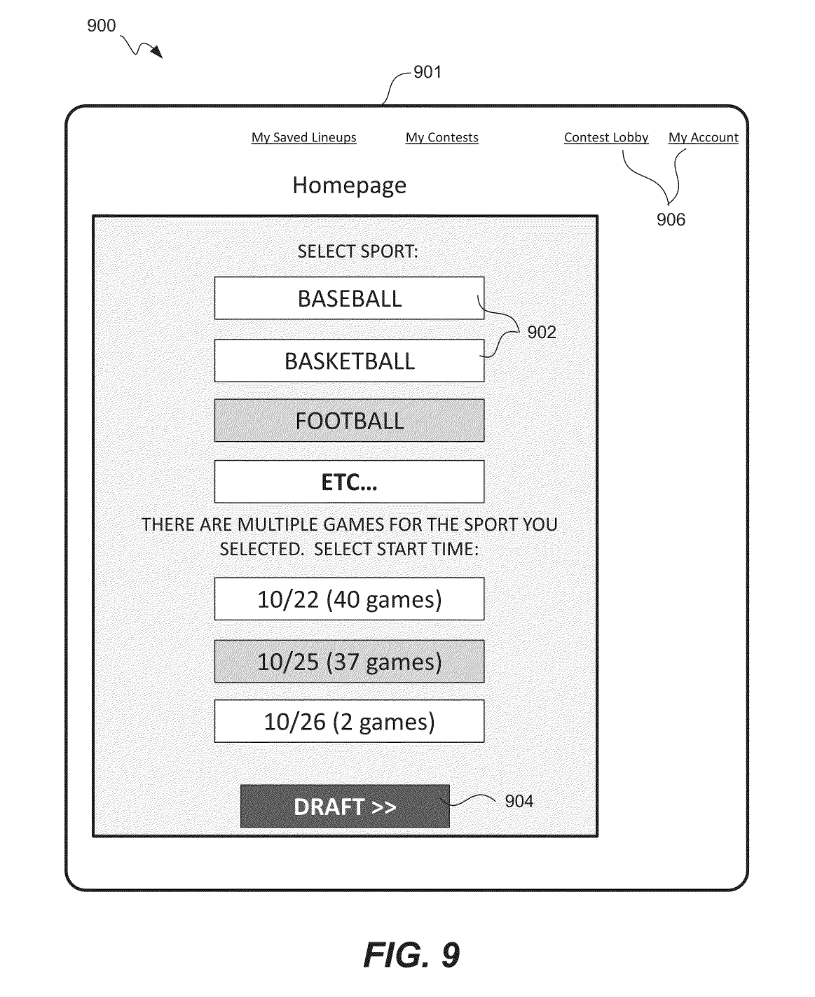

Further examples in this illustrative process are provided in FIGS. 9-15, which collectively illustrate further images of exemplary graphical user interfaces for providing a predictive fantasy sports game to a game participant on a computing device. For example, FIG. 9 provides a GUI 900 for a “Homepage” interface or web page that can be displayed to a game participant when first accessing a predictive based scoring fantasy sports or games system. A window or border 901 can define the homepage GUI 900, such that other displays, windows or visual presentations (not shown) might also be available to the user at the same time, such as on another browser window. Homepage GUI 900 can include various buttons 902 that can be selected by the user, such as to select a particular sport or date, among other possible options. A draft button 904 can move the user to a draft interface or web page, such as GUI 800 described above. In some embodiments, a user may be required to select a sport and/or a date or number of games before such a draft button 904 might be active. GUI 900 can also provide various links 906 to other interfaces or web pages, as shown.

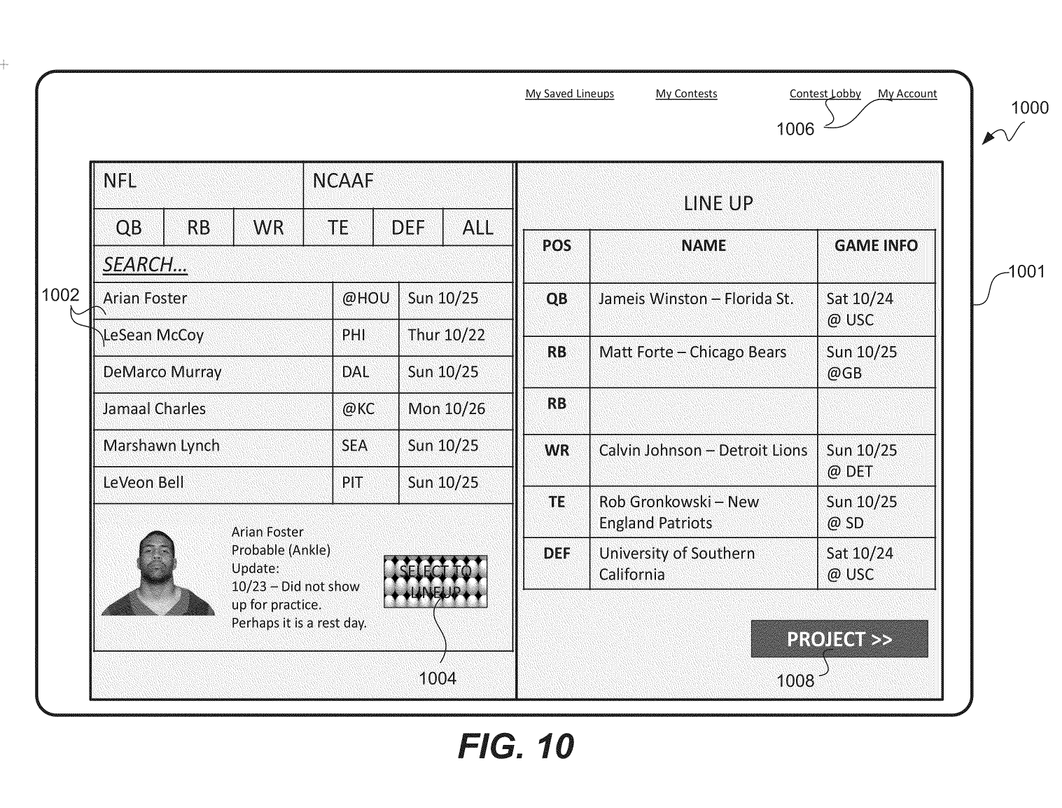

FIG. 10 provides a GUI 1000 for a “Fantasy Team” interface or web page that can be displayed to a game participant to show his or her fantasy team or roster, such as during a draft and/or while selecting a starting lineup for a particular contest or game date. A window or border edge 1001 can define an outer edge of this fantasy team GUI 1000, which can also contain various informational boxes or items 1002, some or all of which may be clickable or selectable by the user. A “Select to Lineup” button 1004 can serve to move or copy a player from the left half or side to the right half or side under the “Lineup” header. GUI 1000 can similarly display various selectable links 1006 to other interfaces or web pages, as shown, and can also provide a “Project” button 1008 that can function to move the user or game participant to a “Project Statistics” mode, interface, or web page.

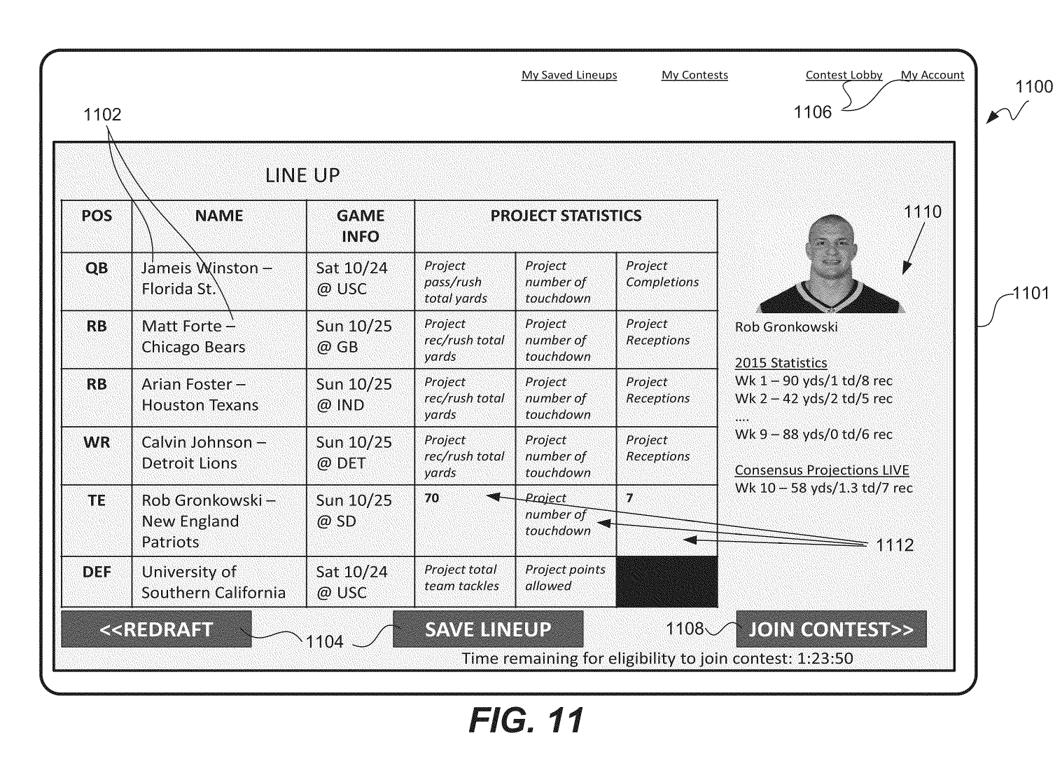

FIG. 11 provides a GUI 1100 for a “Project Statistics” interface or web page that can be provided to a game participant. This GUI 1100 can allow for the predicting or projection of variables or statistics for starting players in the previously selected lineup from GUI 1000. In various embodiments, as referenced above, this “Project Statistics” GUI or game mode enables game participants to project one or more game performance variables or statistics for players on their fantasy teams. Again, an outer border or edge 1101 defines the window or display for GUI 1100, which similarly has various selectable informational items 1102. Various buttons 1104 can permit the user or game participant to “go back” to GUI 1000 or “redraft,” as well as to “save lineup” when finished with all statistical projections. Again, various links 1106 to other pages or other interfaces are also provided on GUI 1100, which can also have a “join contest” button 1108 or other similar user input. An informational region 1110 on a selected or highlighted player from 1102 can display a name, team, picture, and various statistics or informational items.

In addition, a plurality of entry boxes 1112 are provided for the user or game participant to enter his or her projected variables or statistics for each player in the lineup. Such entry boxes 1112 may contain an italicized brief description of the statistic or variable to be predicted, whereupon the user can then enter his or her prediction or projection for the player in each box. As will be readily appreciated, some statistics or variables may be available for predicting for some positions but not others. Further, some positions may require more predictions or projections than others, as may be desired by a given games provider and/or selected from available game parameters by various game participants. Upon entry of a given prediction or projection, the italicized brief description may disappear. Alternatively, a faint overlay of the brief description may stay in place, as may be desired. As one particular non-limiting example, a given game participant might project the variables of a quarterback on his or her fantasy team to throw for 320 yards, 2 touchdowns, and 28 completions for a given game. The user or game participant may elect to save lineup and/or join contest once all of the prediction or projection entries are made.

In general, not every game participant will agree with a given consensus projection or any other expert advice from sport media outlets or the like on how a player will perform. As such, the present disclosure introduces a playing experience that enables game participants to utilize the skill of projecting or forecasting the game performance of players on their fantasy teams, which in turn can empower competing participants to be the better “experts” or “analysts.” As such, a unique and new nature of competition in fantasy sports games can be provided. No longer will participants feel dejected and potentially lose a conventional fantasy sport contest by starting a player that underperforms because they “listened to Joe Expert from Fantasy Sports Online.” If a game participant projected that particular player to underperform, then the game participant will benefit from that accurate projection as well as feel a sense of accomplishment for being a better “fantasy guru.” As a result, providing game participants with more control also provides another level of autonomy in the outcome of fantasy sports contests.

Website operators that provide one-day fantasy sports contests and similar gambling sites have argued that fantasy sports is not considered gambling because it is “skill-based” game and not “luck.” While some may argue that the element of injury over the course of a season does provide some measure of luck when drafting a player that may or may not stay healthy, the present disclosure adds another layer of the skill in that projections or predictions are what matter. As such, luck due to injuries is minimized, and skill in projecting performances of who is known to be playing on any given day may be applied to season-long formats as well.

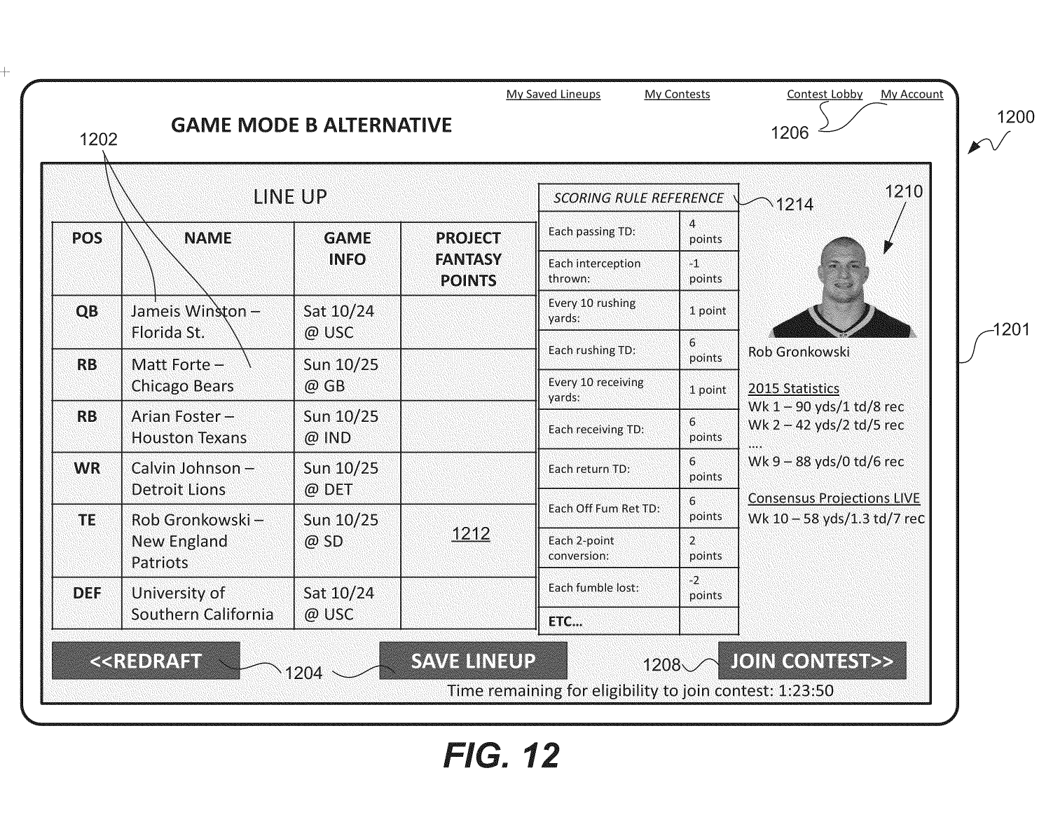

FIG. 12 provides a GUI 1200 for an alternative (Game Mode B) “Project Fantasy Points” interface or web page that can be provided to a game participant. Similar to the foregoing embodiment 1100 in FIG. 11, this alternative Project Fantasy Points GUI 1200 can also allow for the predicting or projection of performances for starting players in the lineup. Unlike projecting various individual statistics or variables like in the previous example, however, this alternative game format allows game participants to predict or project overall fantasy points (i.e., for combined statistical performances). Again, an outer border or edge 1201 defines the window or display for GUI 1200, which has selectable informational items 1202, such as players on the team. Again, various buttons 1204 can permit the user or game participant to redraft or save lineup when finished with all statistical projections, and various links 1206 to other pages or other interfaces are also provided on GUI 1200, which can also have a “join contest” button 1208 or other similar user input. A similar informational region 1210 on a selected or highlighted player can display a name, team, picture, and various statistics or informational items.

Various input boxes 1212 are also provided for the user or game participant to enter his or her predictions or projections as to the overall fantasy points scored for each player in the lineup. As will be readily appreciated, the “fantasy points” scored by a player is a sum point value of various game or statistical achievements that are awarded points. The actual game performance statistics of a player are converted to a score per the scoring rules of the fantasy game contest. A sample scoring rule reference 1214 is provide to give various examples of different things that can result in points that accumulate for an overall fantasy score for a player. Of course, other point values and/or other scoring categories may also be used, as may be desired.

The concept for Game Mode B (i.e., Project Fantasy Points) is similar to the foregoing example where a game participant is still projecting player performance. The prediction or projection, however, is based on factoring how points are scored overall based on various actual game performance statistics. While some game participants may prefer the more detailed breakdowns that are available in the previous example, other game participants may prefer this overall fantasy point projection mode where only one overall projection is made per player. It is specifically contemplated that either version, or some combination thereof, can be used with the various embodiments disclosed herein. In comparing the example given above for a quarterback who is predicted or “projected” to throw for 320 yards, 2 touchdowns, and 28 completions for a given game, scoring rules are applied to arrive at a total point prediction. Here if the scoring rules call for 1 fantasy point for every 25 yards passing, 4 fantasy points for every touchdown, and 1 fantasy point for every completion, then the projected fantasy points would be 48.8 (i.e., 12.8+8+28). A detailed break down of each statistical category is not required for this alternative game mode, and a game participant may simply eyeball how he or she feels the player will do, and enter a “project fantasy points” value of about 48 or 50 into the appropriate box 1212.

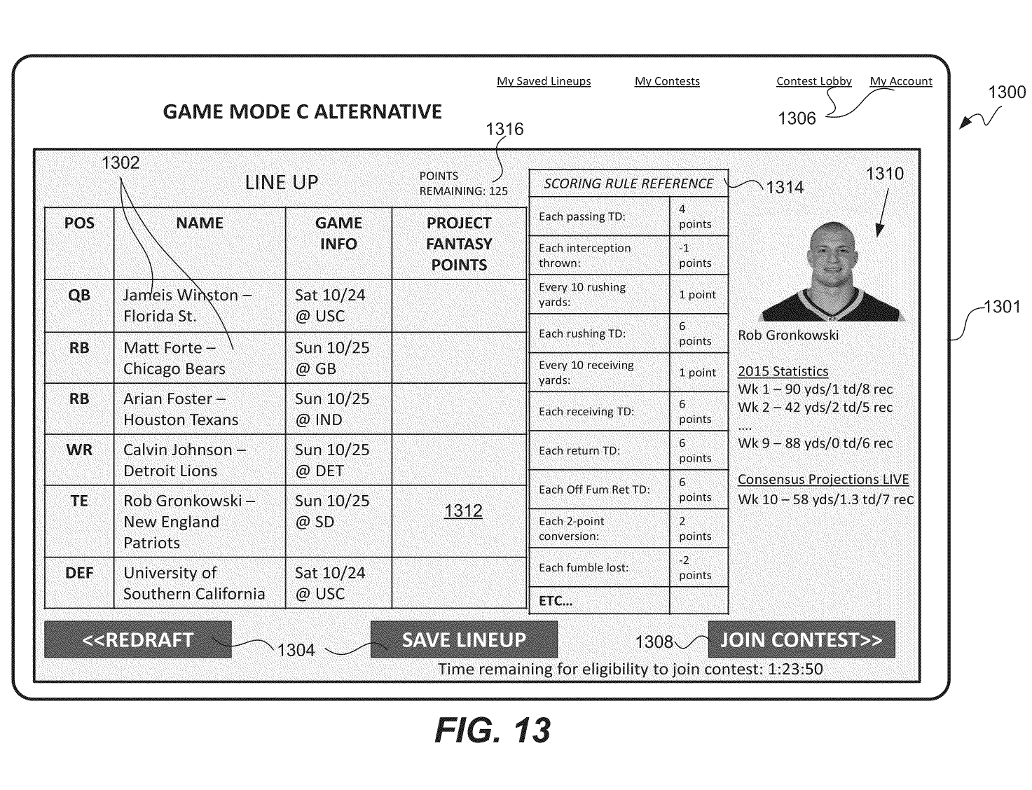

FIG. 13 provides a GUI 1300 for another alternative (Game Mode C) “Point Cap” interface or web page that can be provided to a game participant. Similar to the foregoing embodiments 1100 and 1200 in FIGS. 11 and 12, this further alternative Point Cap game mode can also allow for the predicting or projection of performances for starting players in the lineup. Overall fantasy points are projected as in game mode B, but the difference here is that there is an overall cap or budget on how many points can be used. Similar to the foregoing embodiments, GUI 1300 can have an outer edge or border 1301, various selectable informational items 1302, various input buttons 1304, various links 1306 to other pages or other interfaces, a “join contest” button 1308, a player informational region 1310, and projection input boxes 1312. A scoring rule reference table 1314 and an overall fantasy points cap or budget balance 1316 may also be provided.

In such a “Point Cap” fantasy game embodiment, a game participant is provided with an overall budget or cap on the total amount of fantasy points that he or she can distribute across all starting players. This embodiment expands on the “Project Fantasy Points” game mode, and adds a degree of difficulty in that game participants are not allowed an unlimited amount of fantasy points in making their projections. As such, game participants must strategically distribute fantasy points among the members in the fantasy team. There is no limit as to how many points a game participant can assign to any given player on the fantasy team, so long as the overall number of points projected for the whole team does not exceed the total budget of points allowed to be distributed.

For instance, a given one day point cap fantasy football contest might have a cap of 125 fantasy points. Of course, other values are also possible. As such, a game participant in that contest may only allocate up to 125 points total for the entire fantasy team to qualify for a contest entry. As a particular non-limiting example, a given game participant might project 48.8 fantasy points for the quarterback position, 32.2 fantasy points for one wide receiver position, 11 fantasy points for a second wide receiver position, 11 fantasy points for a running back position, 11 fantasy points for another running back position, and 11 fantasy points for a defensive team position. The total for all positions then is 125 fantasy points, such that the point cap has not been exceeded. Of course, a game participant may desire to project less than the overall cap if desired.

For any of the foregoing embodiments or any other variation that may be implemented according to the provided disclosure, the gist of these various predictive fantasy game systems is to award higher scores based upon the accuracy of the projections for the performances of the players in the starting lineup. As such, a scoring system is used that qualitatively measures the accuracy or closeness of projected variables, statistics, or overall fantasy points respective to the actual game performance variables. Accuracy can be based on a percentage, for example, when comparing the projected with the actual variables or statistics. Points or score can then be awarded to the game participant based upon a better percentage. Alternatively, such a percentage may be transcribed into a “letter-grade,” such as A, B, C, D, or F as well.

In general, the closer the projected variable is to the respective actual outcome variable, the better the accuracy score. Various formulas and examples are provided now for purposes of illustration. It is understood that many other suitable formulas and approaches can be used for assigning score qualitatively based upon the accuracy of predictions or projections, and all such other suitable formulas and approaches are also contemplated for use with the disclosed embodiments. For the formulas below, the assumption is out of 100% total per position in a starting lineup, particular to game mode B and C, for purposes of simplicity in discussion, since game participants only project one variable or score for each player in those game variations.

In determining accuracy and assigning or awarding score or points under a “Project Fantasy Points” and/or “Point Cap” Scoring System, then the formula:

(Projected Game Performance Data/Actual Game Performance Data)×100

can be used to calculate the percentage accuracy of an under-projected variable (e.g., fantasy points projection) by the game participant. If a variable is over-projected, however, then the formula:

[(Projected Game Performance Data−Actual Game Performance Data)/Actual Game Performance Data]×100

can be used to calculate the percentage inaccuracy of the an over-projected variable by the game participant. This inaccuracy percentage can then be subtracted from 100 to yield a percentage accuracy. Any negative value yielded from the difference can be assigned an automatic 0% accuracy for that over-projected variable.

The general formulas above may be applicable to game mode B or C for calculating the accuracy of a single projected variable with respect to the actual outcome variable. For example, if an under-projected variable is 73 and the actual variable performed in a game is 88, then the projected variable is 82.95% accurate in relation to the actual variable (i.e., (73/88)×100). As another example, if an over-projected variable is 150 and the actual game performance variable is 88, then the projected variable is 29.54% accurate (i.e., 100−[[(150-88)/88]×100]). Again, this is only one example of how to calculate accuracy of a single variable projection, and it is specifically contemplated that other approaches might also be used. For example, bonus points might be award for projections that are exact or very accurate, such that a gradated scoring system under a more complex formula might be used in lieu of a fully linear scoring approach.

In various embodiments, the opposite of this high accuracy approach can also be used to determine a fantasy contest outcome. That is, if inaccuracy is calculated rather than accuracy with respect to projections, then the game participant with the highest inaccuracy percentage could lose the fantasy contest. Under such embodiments, a cumulative “inaccuracy” score can be tabulated, such that a perfect score might be zero.

In various embodiments where multiple variables or statistics are predicted or projected for each fantasy player in the lineup, each variable or statistic may be graded the same or on a weighted scale, as may be desired. A similar analysis to the foregoing formula can be done for each variable or statistic, with an overall accuracy or inaccuracy score then being provided for each player. The option to have weighted scoring may be preferable in some embodiments, since some game performance variables tend to have much higher standard deviations than others (e.g., touchdowns vs. yards), such that unweighted scoring can dramatically affect the accuracy scoring of a player in favor of one particular category. For example, if a game participant projects 1 touchdown but the player actually scores 3 touchdowns, then that single badly projected statistic or game variable can carry undue weight against the overall score of a player, particularly where yardage and/or other variables are accurately projected.

For one illustrative example with respect to individual statistics or variables, which again can be accomplished in many other suitable ways and approaches, an under-projected variable can use the formula:

(Projected Game Performance Data/Actual Game Performance Data)×Y

which can be used to calculate the percentage accuracy of the under-projected variable by the game participant where Y is a subset value out of 100 total (mirroring a 100% score). If a variable is over-projected, however, then the formula:

[(Projected Game Performance Data−Actual Game Performance Data)/Actual Game Performance Data]×Y

can be used to calculate the percentage inaccuracy of the over-projected variable by the game participant where Y is a subset value out of 100 total. This inaccuracy percentage can then be subtracted from Y to yield a percentage accuracy. Any negative value yielded from the difference can be an automatic 0% accuracy for that over-projected variable, since the game participant over-projected far too much, in fact more than doubling the actual variable outcome.

Using the above exemplary formulas and the previous examples of projected performance, a game participant can project the variables of a quarterback in their starting lineup to throw for 320 yards, 2 touchdowns, and 28 completions, while the actual game outcome variables are 337 yards, 3 touchdowns, and 26 completions, respectively. If, for example, yards are scored on a 70% scale, touchdowns are scored on a 10% scale, and completions are scored on a 20% scale (totaling 100%), then respectively the value of Y can be 70, 10 and 20 in the above formulas (totaling 100). As such, yards will yield a 66.47% accuracy value, touchdowns will yield a 6.67% accuracy value, and completions will yield a 18.46% accuracy value. Therefore, the overall percent accuracy for this position in the starting lineup is the sum of the percent accuracies for each projected variable. Here, the total accuracy value would be 91.60% after each variable is compared, weighted, and then summed together. Again, different weighting values might be used, and overall different approaches to calculating accuracy might also be implemented.

Ultimately, an overall percent accuracy score for an overall starting lineup can be assigned to a participant after the fantasy match up or contest. This might be done by adding up all of the individual player accuracies, or by averaging the overall percent accuracy of each player in the starting lineup. In such an arrangement, when all players in the starting lineup have finished playing the real games and the player performance data are all in, the game participant with the highest total or average percent accuracy wins the fantasy game or contest. Of course, many other alternative scoring approaches are also possible. For example, accuracy points can be assigned based on how accurate projections are for a given player, whereupon the overall accuracy points can be summed for a total score for a given game participant.

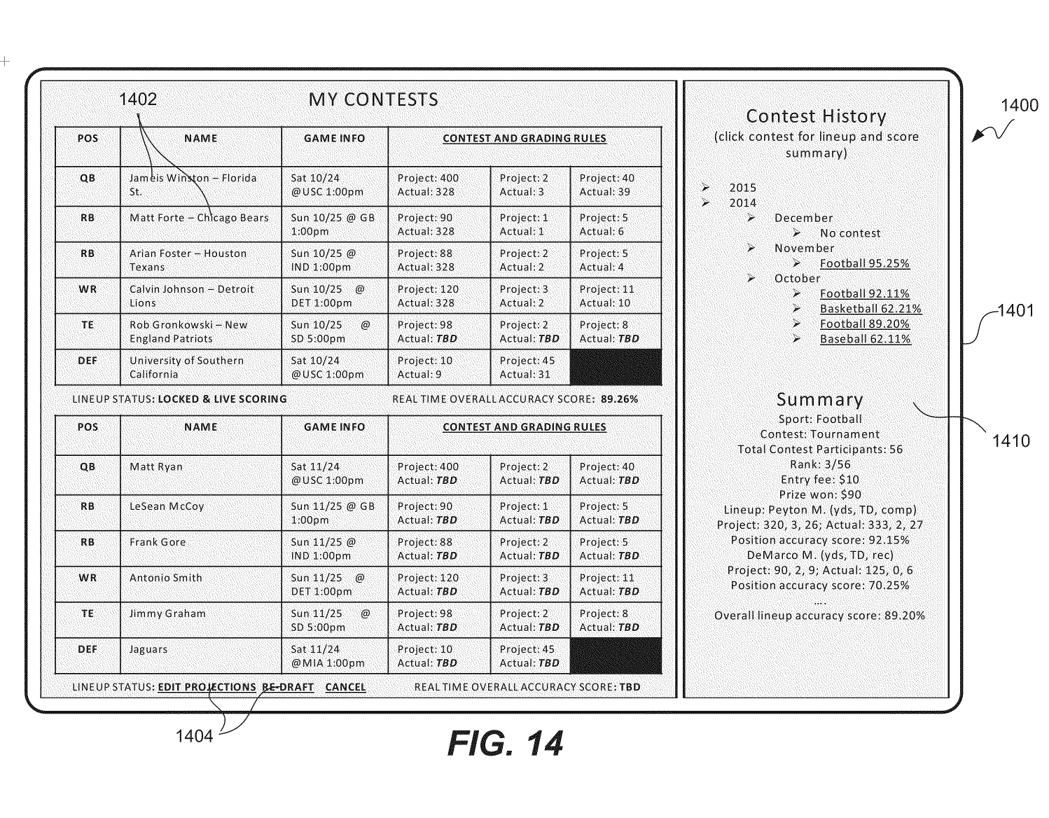

Turning now to FIG. 14, a GUI 1400 for a “My Contests” interface or web page is provided. Such a My Contests page can provide a user with a summary of all of his or her current different teams and/or games or contests. GUI 1400 can have an outer border or edge 1401, various informational items 1402, and various buttons 1404 that permit the user or game participant to “edit” or “redraft,” or “cancel,” such as if at least one player has not actually played yet in real life. A contest history informational region 1410 can provide various statistics, outcomes, pictures, and/or other information of interest to the user. Various other informational items may be presented to the user as may be desired, and one or more links or buttons can be available for the user to navigate away to other interfaces or pages when desired.

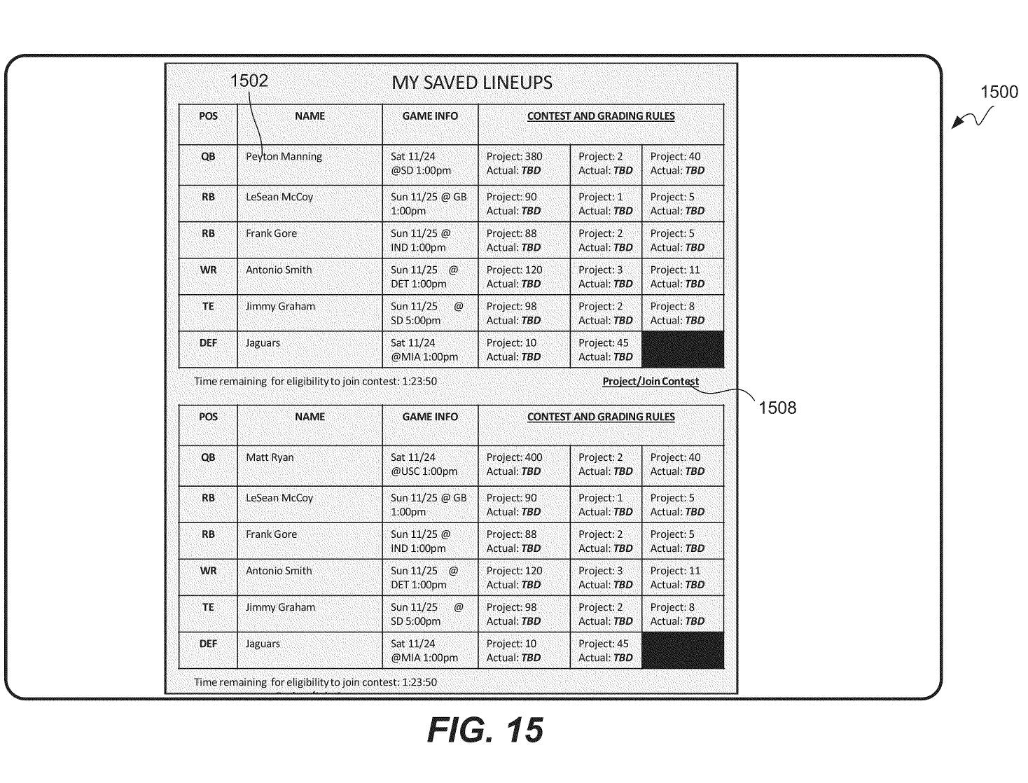

FIG. 15 provides a GUI 1500 for a “My Saved Lineups” interface or web page that can be provided to a game participant. This GUI 1500 can similarly have various selectable informational items 1502, as well as one or more buttons or links 1508 that provide the game participant with options on how to manage his or her fantasy team or teams, such as to join a new fantasy game or contest. Again, other informational items can also be provided to the user, along with the ability to manage and enter multiple fantasy teams or lineups into multiple different fantasy games or contests.

In various further embodiments, which can be provided in addition to any or all of the foregoing embodiments, one or more added details or features can be implemented. For example, a fantasy game can be provided where the projection of variables for starting lineup members in fantasy games or contests are not limited to overall game totals. That is, such variable projections may be for the entire game, and/or also for different time periods, such as by half or by quarter. In addition to one-week or one time fantasy contests, the predictive fantasy games and systems disclosed herein can also be used across season long fantasy games or leagues. As such, game participants may create or join fantasy sport leagues that have more than one weekly contest, such that weekly contest wins might seed game participants into playoff spots, and/or overall accuracy points or scores can be accumulated over an entire season. As yet another game mode or contest variation, another game participant or game administrator can set a starting lineup of players, whereupon each of the game participants active in the game can then project statistics or variables for the players that are already provided.

As noted above, various embodiments of the present disclosure can also include the accumulation and provision of data regarding projected player performance. That is, as some game participants enter their player projections, this data can be amassed and made available to subsequent game participants when they go to enter their projections. Such data can also be made available to game participants who return to rethink and possibly change their player projections. For example, where a game participant enters 100 yards for a given running back early in the week, but then checks back several days later to see that the consensus projection is only 40 yards, that game participant may elect to lower his or her yardage projection for that player.

In various embodiments, a “projectinterface” can be provided to make such data available to game participants. In this projection interface, there can be a “research toolkit” that provides statistical and/or information of past game performance for a particular player that is selected in a starting lineup. Data for the research toolkit can be imported from a fantasy sport data and content provider. This research toolkit may also contain the consensus projection of a variable (in real-time) for a member in a starting lineup whereby the data for this consensus projection is obtained through the collective projections of the variable for that same member. For example, if five game participants in different fantasy contests also drafted Peyton Manning in their starting lineup and projected the statistical variable of passing yards as (300, 248, 350, 320, 299), then the consensus projection (i.e., average) will show as 303 in the research toolkit. Other information and averages may also be provided to game participants and other individuals, as will be readily appreciated.

In various embodiments, a “contest lobby” can be provided as a forum of various contests (e.g., head to head matchups, tournaments, fixed lineup challenges) that can be filtered by game mode. One or more fantasy games or contests in the contest lobby can provide a name or header, pertinent rules or details, and can have a game participant counter tallying the amount of competing game participants or submitted starting lineups for that particular contest. Each contest listing can have a “Join” button or similar input next to it for a game participant to join and submit his or her starting lineup. If a game participant clicks on the join button, then the game participant can be taken to an interface where one or more saved starting lineups can be used to enter that contest, if eligible.

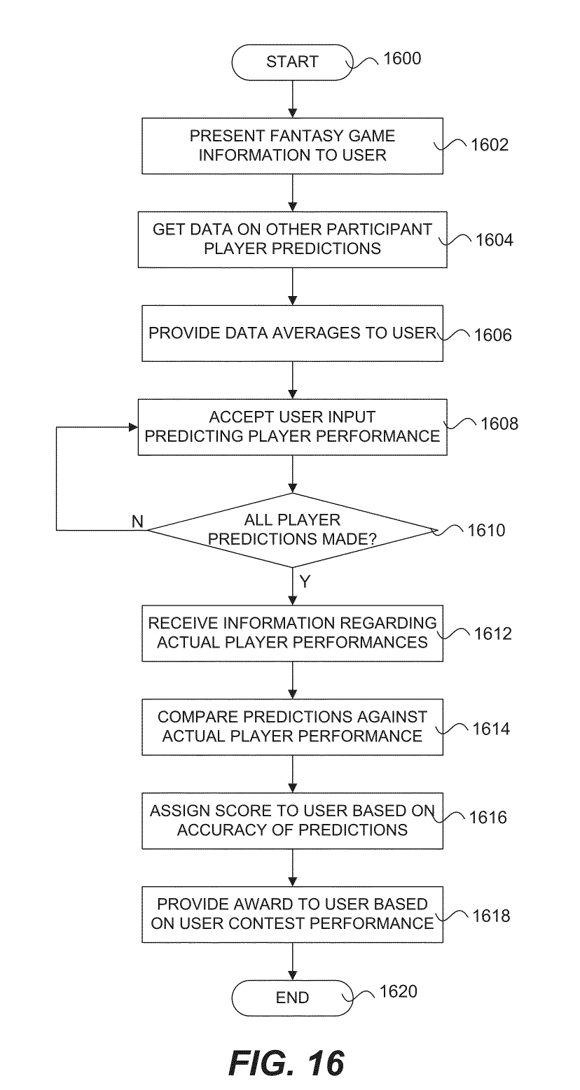

Turning lastly to FIG. 16, a flowchart of an exemplary detailed method of providing a predictive fantasy sports game and data therefor to a fantasy sports game participant according to one embodiment of the present disclosure is provided. After a start step 1600, fantasy game information is provided to a user at a process step 1602. Such information can be provided on a portable device app, browser, or other computing component interface. At process step 1604, data is obtained regarding other game participant player predictions. As noted above, this data can be averaged or otherwise manipulated as desired by a gaming provider or operator. The raw data and/or data averages can then be provided to the user at subsequent process step 1606. Again, this can be done to provide the user and other game participants with consensus projections or other data regarding player predictions or projections.

At a following process step 1608, a user input can be accepted with respect to predicting player performance. Such a user input can be from a game participant who is managing his or her fantasy team roster, and the input can be a prediction regarding a particular variable or statistic for an upcoming event. For example, the prediction can be with respect to rushing yards for a given player. At a decision step 1610, an inquiry can be made as to whether all player predictions have been made. If not, then the process reverts to step 1608, where another user input predicting player performance can be made. Such further user inputs can be additional predictions for the same player, and/or one or more predictions for other players on the fantasy team roster. For example, a second prediction can be for the number of touchdowns scored for the same player as in the first prediction above. One or more still further predictions can also be made for that same player, if desired or as required by game rules or parameters. One or more further predictions can then be made for one, several, or all other starting roster players per the game rules or parameters until all player predictions are made.

After all predictions are made at decision step 1610, the method then moves to process step 1612, where information is received regarding actual player performances in the game or games at issue. The player predictions entered by the game participant are then compared to the actual player performances at process step 1614, after which a score is assigned to the user based on the accuracy of the player predictions at process step 1616. At a subsequent process step 1618, an award can be provided to the user based upon the performance or score of the user in the contest. For example, a simple “award” can simply be the statement that the user has won or lost the contest against an opponent. Other awards or prizes are also possible. The method then ends at end step 1620.

For the foregoing flowchart, it will again be readily appreciated that not every method step provided is always necessary, and that further steps not set forth herein may also be included. For example, added steps might include allowing a user login to a game network, providing affirmative feedback whenever a given predictive input is placed, or allowing the user to select or toggle between various players or player categories. Further steps can involve comparing game scores to other users and awarding prizes to high scores, among other possible steps. Furthermore, the exact order of steps may be altered as desired, and some steps may be performed simultaneously. For example, step 1602 may be performed before or after step 1604 in various embodiments. In addition, while the foregoing examples are provided with respect to electronic or computerized predictive fantasy games, it will be readily appreciated that the provided methods can also be used with respect to physical games, other fantasy endeavors beyond sports, and other versions of data storage, processing, and presentation, as well as other alternative embodiments.

Those skilled in the art will readily appreciate that any of the systems and methods of the disclosure may include various computer and network related software and hardware, such as programs, operating systems, memory storage devices, data input/output devices, data processors, servers with links to data communication systems, wireless or otherwise, and data transceiving terminals, and may be a standalone device or incorporated in another platform, such as an existing electronic gaming machine, portable computing device or electronic platforms with multiple player positions. In addition, the system of the disclosure may be provided at least in part on a personal computing device, such as home computer, laptop or mobile computing device through an online communication connection or connection with the Internet. Those skilled in the art will further appreciate that the exact types of software and hardware used are not vital to the full implementation of the methods of the disclosure so long as players and operators thereof are provided with useful access thereto or the opportunity to play the game as described herein.

The various aspects, embodiments, implementations or features of the described embodiments can be used separately or in any combination. Various aspects of the described embodiments can be implemented by software, hardware or a combination of hardware and software. Computer readable medium can be any data storage device that can store data which can thereafter be read by a computer system. Examples of computer readable medium include read-only memory, random-access memory, flash drives, USB drives, CD-ROMs, DVDs, magnetic disk drives, magnetic tape, optical data storage devices, and carrier waves. The computer readable medium can also be distributed over network-coupled computer systems so that the computer readable code is stored and executed in a distributed fashion.

Although the foregoing disclosure has been described in detail by way of illustration and example for purposes of clarity and understanding, it will be recognized that the above described disclosure may be embodied in numerous other specific variations and embodiments without departing from the spirit or essential characteristics of the disclosure. Certain changes and modifications may be practiced, and it is understood that the disclosure is not to be limited by the foregoing details, but rather is to be defined by the scope of the appended claims.

1.-20. (canceled)

21. A method of providing a skill based award to a user over a network to a remote client computer, the method comprising:
providing a fantasy game application to the user for installation on the remote client computer;
accepting user selections at a server system sent from the remote client computer regarding the management of a user fantasy team for play in a fantasy game, the server system including a processor and a memory that stores the user selections;
receiving additional fantasy game information at the server system sent from at least one separate data source over the network, wherein the additional fantasy game information includes information regarding an actual statistical performance of at least one player or activity;
assigning automatically by the processor at least a portion of a user score to the user for the fantasy game based on the user selections; and
providing the skill based award to the user over the network based on the skill of the user in making the user selections to result in the user score for the fantasy game,
wherein said user selections include specific statistical predictions forming a predicted statistical performance of the at least one player or activity on the user fantasy team prior to the actual performance taking place, and wherein the skill based award is provided based on the accuracy of the predicted statistical performance in comparison with the actual statistical performance.

22. The method of claim 21, further comprising:
comparing automatically by the processor the predicted statistical performance with the actual statistical performance for the at least one player or activity.

23. The method of claim 21, wherein the additional fantasy game information further includes other predicted statistical performances of the least one player or activity, the other predicted statistical performances resulting from selections of other users.

24. The method of claim 23, further comprising:
providing data to the user over the network regarding the other predicted statistical performances, said providing data taking place prior to the actual performance taking place.

25. The method of claim 24, wherein said providing data takes place prior to the accepting user selections takes place.

26. The method of claim 24, wherein said data includes calculated averages of other predicted statistical performances.

27. The method of claim 21, wherein the network is the Internet.

28. The method of claim 21, wherein the fantasy game is a fantasy sports game.

29. The method of claim 28, wherein the fantasy sports game involves the simultaneous use of players from a professional sports league and players from a collegiate sports league.

30. The method of claim 21, wherein the fantasy game limits the user to an overall budget cap for the sum of all predicted statistical performances for all players and activities on the user fantasy team.

31. The method of claim 21, wherein a greater accuracy of the predicted statistical performance in comparison with the actual statistical performance results in a higher user score.

32. A non-transitory computer readable medium including at least computer program code executable on a server system processor for providing a skill based award to a user over a network, the non-transitory computer readable medium comprising:
computer program code for providing a fantasy game application to the user for installation on the remote client computer;
computer program code for accepting user selections at a server system sent from the remote client computer regarding the management of a user fantasy team for play in a fantasy game, the server system including the processor and a memory that stores the user selections;
computer program code for receiving additional fantasy game information at the server system sent from at least one separate data source over the network, wherein the additional fantasy game information includes information regarding an actual statistical performance of at least one player or activity;
computer program code for assigning at least a portion of a user score to the user for the fantasy game based on the user selections; and
computer program code for providing the skill based award to the user over the network based on the skill of the user in making the user selections to result in the user score for the fantasy game,
wherein said user selections include specific statistical predictions forming a predicted statistical performance of the at least one player or activity on the user fantasy team prior to the actual performance taking place, and wherein the skill based award is provided based on the accuracy of the predicted statistical performance in comparison with the actual statistical performance.

33. The non-transitory computer readable medium of claim 32, further including:
computer program code for comparing the predicted statistical performance with the actual statistical performance for the at least one player or activity.

34. The non-transitory computer readable medium of claim 32, wherein the additional fantasy game information further includes other predicted statistical performances of the least one player or activity, the other predicted statistical performances resulting from selections of other users, and further comprising:
computer program code for providing data to the user over the network regarding the other predicted statistical performances, said providing data taking place prior to the actual performance taking place.

35. The non-transitory computer readable medium of claim 32, wherein the fantasy game is a fantasy sports game.

36. A system server configured to provide a skill based award over a network to a remote client computer, the system server including at least one processor and at least one memory, wherein the system server is configured to:
facilitate providing a fantasy game application to the user for installation on the remote client computer;
accept user selections sent from the remote client computer regarding the management of a user fantasy team for play in a fantasy game;
receive additional fantasy game information sent from at least one separate data source over the network, wherein the additional fantasy game information includes information regarding an actual statistical performance of the at least one player or activity;
assigning automatically by the processor at least a portion of a user score to the user for the fantasy game based on the user selections; and
providing the skill based award to the user over the network based on the skill of the user in making the user selections to result in the user score for the fantasy game,
wherein said user selections include specific statistical predictions forming a predicted statistical performance of the at least one player or activity on the user fantasy team prior to the actual performance taking place, and wherein the skill based award is provided based on the accuracy of the predicted statistical performance in comparison with the actual statistical performance.

37. The system server of claim 36, wherein the system server is further configured to:
compare predicted statistical performance with the actual statistical performance for the at least one player or activity.

38. The system server of claim 36, wherein a greater accuracy of the predicted statistical performance in comparison with the actual statistical performance results in a higher user score.

39. The system server of claim 36, wherein a least a portion of the user score is determined by calculating a percentage difference of a predicted statistic for a player performance from the actual statistic for the player performance.

40. The system server of claim 39, wherein all of the user score is determined by calculating percentage differences of predicted statistics for player performances from actual statistics for player performances.
